(19) United States
(12) Patent Application Publication
(10) Pub. No.: US 2023/0096999 A1
(43) Pub. Date: Mar. 30, 2023

(54) TERMINAL AND METHOD PERFORMED BY THE SAME IN WIRELESS COMMUNICATION SYSTEM

(71) Applicant: Samsung Electronics Co., Ltd., Gyeonggi-do (KR)

(72) Inventors: Sa ZHANG, Beijing (CN); Feifel Sun, Beijing (CN); Jingxing Fu, Beijing (CN)

(21) Appl. No.: 17/955,832

(22) Filed: Sep. 29, 2022

(30) Foreign Application Priority Data
Sep. 29, 2021 (CN) 202111151510.5
Nov. 3, 2021 (CN) 202111296508.7
Nov. 9, 2021 (CN) 202111320004.4
Jan. 7, 2022 (CN) 202210015841.4
Jan. 14, 2022 (CN) 202210044974.4
Feb. 11, 2022 (CN) 202210130346.8
Feb. 24, 2022 (CN) 202210174088.3

(51) Int. Cl. H04W 72/04; H04L 5/00; H04L 1/18; H04W 72/10

(52) U.S. Cl. CPC H04W 72/0413; H04L 5/0055; H04L 1/1812; H04W 72/10

(57) ABSTRACT

A terminal and a method performed by the terminal in a wireless communication system are provided. The method includes receiving a RRC message including information related to a SPS HARQ deferral, performing at least one of multiplexing or prioritization among a first PUCCH and one or more uplink channels when the first PUCCH overlaps with the one or more uplink channels, identifying a PUCCH resource for a PUCCH transmission with HARQ-ACK information for SPS PDSCH receptions based on a result of performing at least one of the multiplexing or the prioritization in a first slot, determining a second slot based on the RRC message, when the PUCCH resource overlaps with at least one of a downlink symbol, an SS/PBCH block or a CORESET0, and transmitting the HARQ-ACK information for the SPS PDSCH receptions in the second slot.

### CROSS-REFERENCE TO RELATED APPLICATIONS

This application is based on and claims priority under 35 U.S.C. § 119 to Chinese Patent Application Nos. 202111151510.5, 202111296508.7, 202111320004.4, 202210015841.4, 202210044974.4, 202210130346.8, and 202210174088.3, which were filed with the China National Intellectual Property Administration (CNIPA) on Sep. 29, 2021, Nov. 3, 2021, Nov. 9, 2021, Jan. 7, 2022, Jan. 14, 2022, Feb. 11, 2022, and Feb. 24, 2022, respectively, the entire content of each of which is incorporated herein by reference.

### BACKGROUND

### 1. Field

The disclosure relates generally to wireless communication, and in particular, to a terminal and a method performed by the same in a wireless communication system.

### 2. Description of the Related Art

In order to meet the increasing demand for wireless data communication services since the deployment of 4^{th} generation (4G) communication systems, efforts have been made to develop improved 5^{th} generation (5G) or pre-5G communication systems. 5G or pre-5G communication systems may also called referred to as “beyond 4G networks” or “post-long term evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming, and large-scale antenna are discussed in 5G communication systems.

In addition, in 5G communication systems, development of system network improvements are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA), and sparse code multiple access (SCMA) as advanced access technologies have been developed.

### SUMMARY

In accord with an embodiment of the disclosure, there is provided a method performed by a terminal in a wireless communication system. The method includes receiving a radio resource control (RRC) message including information related to a semi persistent scheduling (SPS) hybrid automatic repeat request (HARQ) deferral, performing at least one of multiplexing or prioritization among a first physical uplink control channel (PUCCH) and one or more uplink channels when the first PUCCH overlaps with the one or more uplink channels, identifying a PUCCH resource for a PUCCH transmission with HARQ-acknowledgement (ACK) information for SPS physical data shared channel (PDSCH) receptions based on a result of performing at least one of the multiplexing or the prioritization in a first slot, determining a second slot based on the RRC message, when the PUCCH resource overlaps with at least one of a downlink symbol, a synchronization signal and physical broadcast channel (SS/PBCH) block or a control resource set0 (CORESET0), and transmitting the HARQ-ACK information for the SPS PDSCH receptions in the second slot.

In accord with another embodiment of the disclosure, there is provided a method performed by a base station (BS) in a wireless communication system. The method includes transmitting a radio resource control (RRC) message including information related to a semi persistent scheduling (SPS) hybrid automatic repeat request (HARQ) deferral, and when a physical uplink control channel (PUCCH) resource for a PUCCH transmission with HARQ-Acknowledgement (ACK) information for SPS physical data shared channel (PDSCH) receptions overlaps with at least one of a downlink symbol, a synchronization signal and physical broadcast channel (SS/PBCH) block or a control resource set 0 (CORESET0), receiving the HARQ-ACK information for the SPS PDSCH receptions in a second slot determined based on the RRC message, wherein the PUCCH resource is identified based on the result of at least one of multiplexing or prioritization in a first slot among a first PUCCH and one or more uplink channels when the first PUCCH overlaps with the one or more uplink channels.

In accordance with another embodiment of the present disclosure, a terminal is provided for use in a wireless communication system. The terminal includes a transceiver, and a controller configured to receive a radio resource control (RRC) message including information related to a semi persistent scheduling (SPS) hybrid automatic repeat request (HARQ) deferral, perform at least one of multiplexing or prioritization among a first physical uplink control channel (PUCCH) and one or more uplink channels when the first PUCCH overlaps with the one or more uplink channels, identify a PUCCH resource for a PUCCH transmission with HARQ-acknowledgement (ACK) information for SPS physical data shared channel (PDSCH) receptions based on a result of performing at least one of the multiplexing or the prioritization in a first slot, determine a second slot based on the RRC message, when the PUCCH resource overlaps with at least one of a downlink symbol, a synchronization signal and physical broadcast channel (SS/PBCH) block or a control resource set0 (CORESET0), and transmit the HARQ-ACK information for the SPS PDSCH receptions in the second slot.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment;

FIGS. 2A and 2B illustrate wireless transmission and reception paths according to an embodiment;

FIG. 3A illustrates a user equipment (UE) according to an embodiment;

FIG. 3B illustrates a gNB according to an embodiment;

FIG. 4 illustrates a second transceiving node according to an embodiment;

FIG. 5 is a flowchart illustrating a method performed by a UE according to an embodiment;

FIGS. 6A-6C illustrate uplink transmission timings according to an embodiment;

FIG. 7 illustrates a PUCCH overlapping with a PUSCH in time domain according to an embodiment;

FIGS. 8A and 8B illustrate a PUCCH overlapping with a PUSCH in time domain according to an embodiment;

FIG. 9A illustrates a PUCCH overlapping with a PUSCH in time domain according to an embodiment;

FIG. 9B illustrates a PUCCH overlapping with a PUSCH in time domain according to an embodiment;

FIG. 9C illustrates HARQ-ACK multiplexing according to an embodiment;

FIG. 10 is a flowchart illustrating a method performed by a terminal according to an embodiment;

FIG. 11 illustrates a first transceiving node according to an embodiment; and

FIG. 12 is a flowchart illustrating a method performed by a BS according to an embodiment.

### DETAILED DESCRIPTION

In order to make the purpose, technical schemes and advantages of the embodiments of the disclosure clearer, the technical schemes of the embodiments of the disclosure will be described clearly and completely with reference to the drawings of the embodiments of the disclosure. The described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like.

The term “controller” means any device, system or part thereof that controls at least one operation. Such a controller can be implemented in hardware or a combination of hardware and software and/or firmware. The functionality associated with any particular controller can be centralized or distributed, whether locally or remotely.

The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Various functions described below can be implemented or supported by one or more computer programs, each of which is formed from computer-readable program code and embodied in a computer-readable medium.

The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory.

A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

Similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system.

For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure.

The technical schemes of the embodiments of the present application can be applied to various communication systems, and for example, the communication systems may include global systems for mobile communications (GSM), code division multiple access (CDMA) systems, wideband CDMA (WCDMA) systems, general packet radio service (GPRS) systems, LTE systems, LTE frequency division duplex (FDD) systems, LTE time division duplex (TDD) systems, universal mobile telecommunications system (UMTS), worldwide interoperability for microwave access (WiMAX) communication systems, 5G systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

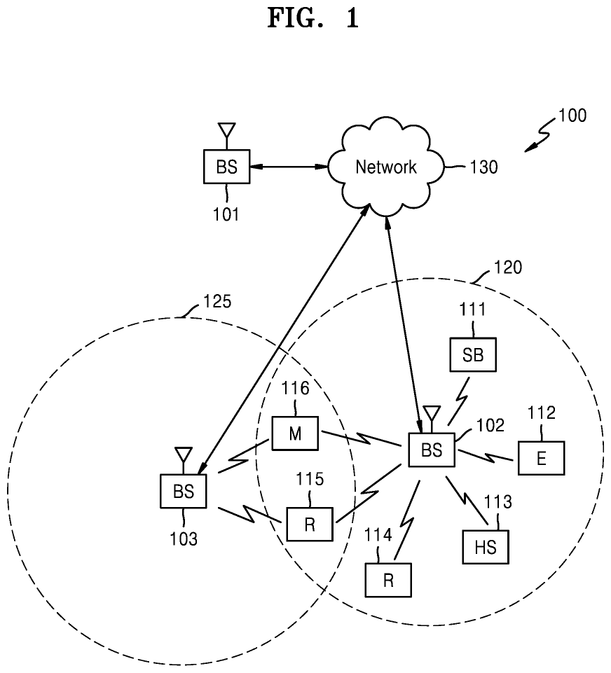

The following FIGS. 1-3B describe various embodiments implemented by using orthogonal frequency division multiplexing (OFDM) or orthogonal frequency division multiple access (OFDMA) communication technologies in wireless communication systems. However, the descriptions of FIGS. 1-3B do not limit physical or architectural implications for the manner in which different embodiments may be implemented. Different embodiments of the disclosure may be implemented in any suitably arranged communication systems.

FIG. 1 illustrates a wireless network according to an embodiment.

Referring to FIG. 1, the wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms such as “BS” or “access point (AP)” can be used instead of “gNodeB” or “gNB”. For convenience, the terms “gNodeB” and “gNB” are used in this patent document to refer to network infrastructure components that provide wireless access for remote terminals. Depending on the type of the network, other well-known terms such as “mobile station”, “user station”, “remote terminal”, “wireless terminal” or “user apparatus” can be used instead of “UE”. For example, the terms “terminal”, and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of UEs within a coverage area 120 of gNB 102. The first plurality of UEs include a UE 111, which may be located in a small business (SB); a UE 112, which may be located in an enterprise (E); a UE 113, which may be located in a WiFi hotspot (HS): a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. gNB 103 provides wireless broadband access to network 130 for a second plurality of UEs within a coverage area 125 of gNB 103. The second plurality of UEs include the UE 115 and the UE 116. In some embodiments, one or more of gNBs 101-103 can communicate with each other and with UEs 111-116 using 5G, LTE, LTE advanced (LTE-A), WiMAX or other advanced wireless communication technologies.

The dashed lines in FIG. 1 represent approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2-dimensional (2D) antenna array. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Further, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

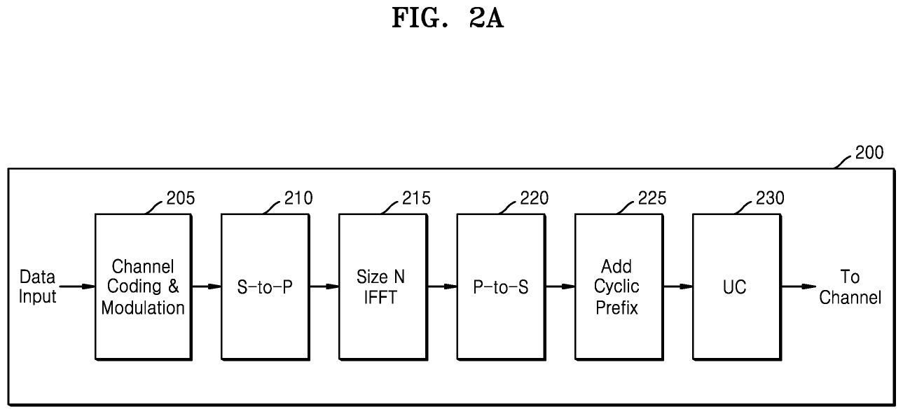

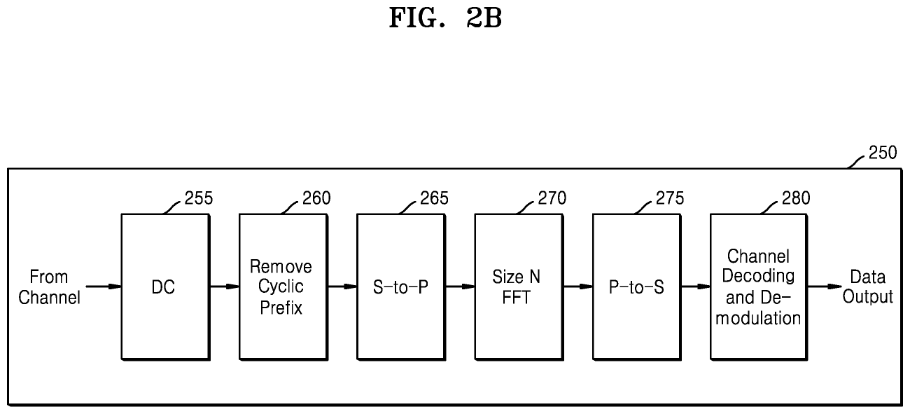

FIGS. 2A and 2B illustrate transmission and reception paths according to an embodiment.

Referring to FIGS. 2A and 2B, the transmission path 200 may be implemented in a gNB, and the reception path 250 may be implemented in a UE. However, it should be understood that the reception path 250 can be implemented in a gNB and the transmission path 200 can be implemented in a UE. In some embodiments, the reception path 250 is configured to support codebook designs and structures for systems with 2D antenna arrays.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or QAM) to generate a sequence of frequency-domain modulated symbols. The S-to-P block 210 converts (e.g., demultiplexes) serial modulated symbols into parallel data to generate N parallel symbol streams, where N is a size of the IFFT/FFT used in the gNB and the UE. The size N IFFT block 215 performs IFFT operations on the N parallel symbol streams to generate a time domain output signal. The P-to-S block 220 converts (e.g., multiplexes) parallel time domain output symbols from the Size N IFFT block 215 to generate a serial time domain signal. The cyclic prefix addition block 225 inserts a cyclic prefix into the time domain signal. The UC 230 modulates (e.g., up-converts) the output of the cyclic prefix addition block 225 to a radio frequency (RF) frequency for transmission via a wireless channel. The signal can also be filtered at a baseband before switching to the RF frequency.

The RF signal transmitted from the gNB arrives at the UE after passing through the wireless channel, and operations in reverse to those at the gNB are performed at the UE. The DC 255 down-converts the received signal to a baseband frequency, and the cyclic prefix removal block 260 removes the cyclic prefix to generate a serial time domain baseband signal. The S-to-P block 265 converts the time domain baseband signal into a parallel time domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

For example, each of gNBs 101-103 illustrated in FIG. 1 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. For example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Further, although described as using FFT and IFFT, this is only illustrative and should not be interpreted as limiting the scope of the disclosure. Other types of transforms can be used, such as discrete Fourier transform (DFT) and Inverse DFT (IDFT) functions. For DFT and IDFT functions, the value of variable N may be any integer (such as 1, 2, 3, 4, etc.), and for FFT and IFFT functions, the value of variable N may be any integer which is a power of 2 (such as 1, 2, 4, 8, 16, etc.).

Although FIGS. 2A and 2B illustrate wireless transmission and reception paths, various changes may be made to FIGS. 2A and 2B. For example, various components in FIGS. 2A and 2B can be combined, further subdivided or omitted, and additional components can be added according to specific requirements. Further, FIGS. 2A and 2B are intended to illustrate examples of types of transmission and reception paths that can be used in a wireless network. Any other suitable architecture can be used to support wireless communication in a wireless network.

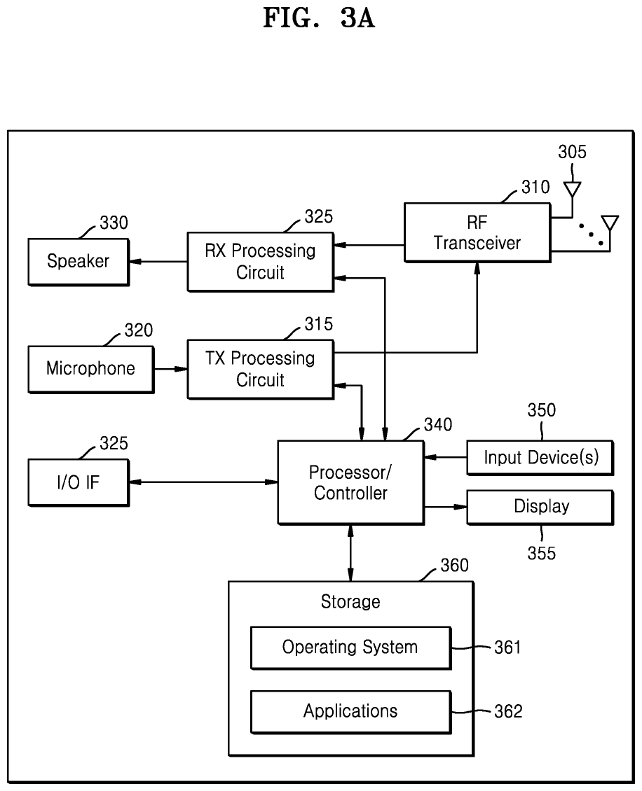

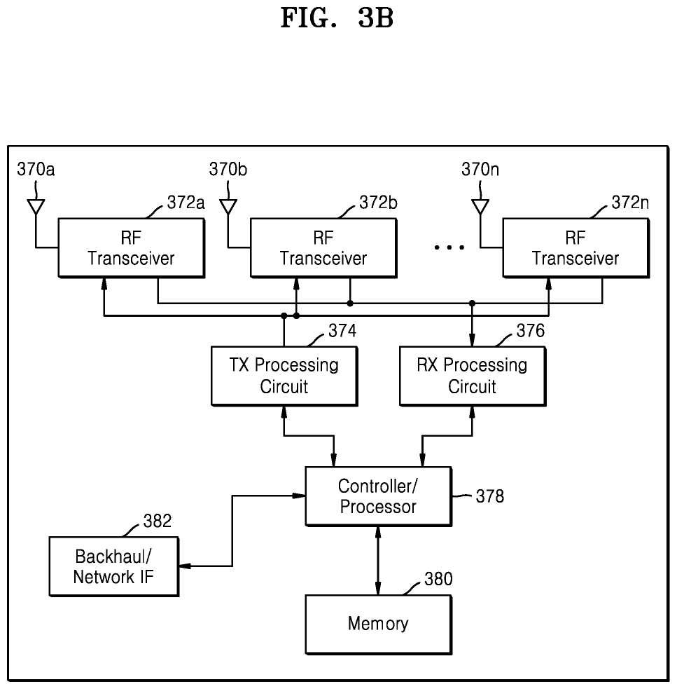

FIG. 3A illustrates a UE according to an embodiment.

Referring to FIG. 3A, the UE includes an antenna 305, an RF transceiver 310, a transmission (TX) processing circuit 315, a microphone 320, and a reception (RX) processing circuit 325. The UE also includes a speaker 330, a processor/controller 340, an input/output (I/O) interface 345, input device(s) 350, a display 355, and a memory 360. The memory 360 includes an operating system (OS) 361 and one or more applications 362.

The RF transceiver 310 receives an incoming RF signal transmitted by a gNB of the wireless network from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (e.g., as voice data) or to processor/controller 340 for further processing (e.g., as web browsing data).

The TX processing circuit 315 receives analog or digital voice data from microphone 320 or other outgoing baseband data (e.g., network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 may execute other processes and programs residing in the memory 360, such as operations for channel quality measurement and reporting for systems with 2D antenna arrays. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE can input data into the UE using the input device(s) 350. The display 355 may be a liquid crystal display (LCD) or other display capable of presenting text and/or at least limited graphics (e.g., a website). The memory 360 is coupled to the processor/controller 340. A part of the memory 360 can include a RAM, while another part of the memory 360 can include a flash memory or other ROM.

Although FIG. 3A illustrates an example of the UE, various changes can be made to thereto. For example, various components in FIG. 3A can be combined, further subdivided or omitted, and additional components can be added according to specific requirements. For example, the processor/controller 340 can be divided into a plurality of processors, such as one or more central processing units (CPUs) and one or more graphics processing units (GPUs). Further, although FIG. 3A illustrates that the UE is configured as a mobile phone or a smart phone, UEs can be configured to operate as other types of mobile or fixed devices.

FIG. 3B illustrates a gNB according to an embodiment.

Referring to FIG. 3B, the gNB includes a plurality of antennas 370a-370n, a plurality of RF transceivers 372a-372n, a TX processing circuit 374, and an RX processing circuit 376. In certain embodiments, one or more of the plurality of antennas 370a-370n include a 2D antenna array. The gNB also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (e.g., voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. The controller/processor 378 may support any of a variety of other functions in the gNB. In some embodiments, the controller/processor 378 includes at least one microprocessor or microcontroller.

The controller/processor 378 may execute programs and other processes residing in the memory 380, such as a basic OS. The controller/processor 378 can also support channel quality measurement and reporting for systems with 2D antenna arrays. In some embodiments, the controller/processor 378 supports communication between entities such as web real time communications (RTCs). The controller/processor 378 can move data into or out of the memory 380 as required by an execution process.

The controller/processor 378 is also coupled to the backhaul or network interface 382. The backhaul or network interface 382 allows the gNB to communicate with other devices or systems through a backhaul connection or through a network. The backhaul or network interface 382 can support communication over any suitable wired or wireless connection(s). For example, when the gNB is implemented as a part of a cellular communication system, such as a cellular communication system supporting 5G or NR, LTE or LTE-A, the backhaul or network interface 382 can allow the gNB to communicate with other gNBs through wired or wireless backhaul connections. When the gNB is implemented as an access point, the backhaul or network interface 382 can allow the gNB to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. Apart of the memory 380 can include a RAM, while another part of the memory 380 can include a flash memory or other ROMs. In certain embodiments, a plurality of instructions, such as the BIS algorithm, are stored in the memory 380. The plurality of instructions are configured to cause the controller/processor 378 to execute the BIS process and decode the received signal after subtracting at least one interference signal determined by the BIS algorithm.

As will be described in more detail below, the transmission and reception paths of the gNB (implemented using RF transceivers 372a-372n, TX processing circuit 374 and/or RX processing circuit 376) support aggregated communication with FDD cells and TDD cells.

Although FIG. 3B illustrates an example of the gNB, various changes may be made to thereto. For example, the gNB can include any number of each component shown in FIG. 3A. For example, the gNB can include many backhaul or network interfaces 382, and the controller/processor 378 can support routing functions to route data between different network addresses. As another example, although shown as including a single instance of the TX processing circuit 374 and a single instance of the RX processing circuit 376, the gNB can include multiple instances of each (e.g., one for each RF transceiver).

Those skilled in the art will understand that, “terminal” and “terminal device” as used herein include devices with wireless signal receivers which have no transmitting capability, and also devices with receiving and transmitting hardware that can carry out bidirectional communication on a bidirectional communication link. Such devices may include cellular or other communication devices with single-line displays or multi-line displays or cellular or other communication devices without multi-line displays; a personal communications service (PCS), which may combine voice, data processing, fax and/or data communication capabilities; a PDA, which may include an RF receiver, a pager, an Internet/intranet access, a web browser, a notepad, a calendar and/or a global positioning system (GPS) receiver; a conventional laptop and/or palmtop computer or other devices having and/or including an RF receiver.

A “Terminal” and “terminal device” as used herein may also be portable, transportable, installed in vehicles (aviation, sea transportation and/or land), or suitable and/or configured to operate locally, and/or in distributed form, operate on the earth and/or any other position in space. A “Terminal” and “terminal device” as used herein may also be a communication terminal, an internet terminal, a music/video playing terminal, such as a PDA, a mobile Internet device (MID) and/or a mobile phone with music/video playing functions, a smart television (TV), a set-top box and other devices.

With the rapid development of information industry, especially the increasing demand from mobile Internet and Internet of things (IoT), it brings unprecedented challenges to the future mobile communication technology. In order to meet the unprecedented challenges, the communication industry and academia have carried out extensive research on the 5G mobile communication technology. The framework and overall goals of the future 5G have been discussed, in which the demand outlook, application scenarios and important performance indicators of 5G are described in detail. With respect to new requirements in 5G, the current technology trends of 5G are directed to solving significant problems such as significantly improved system throughput, consistent user experience, scalability to support IoT, delay, energy efficiency, cost, network flexibility, support of emerging services and flexible spectrum utilization.

In 3rd Generation Partnership Project (3GPP), the first stage of 5G is already in progress. To support more flexible scheduling, the 3GPP decides to support variable hybrid automatic repeat request-acknowledgement (HARQ-ACK) feedback delay in 5G.

In existing LTE systems, a time from reception of downlink data to uplink transmission of HARQ-ACK is fixed. For example, in FDD systems, the delay is 4 subframes. In TDD systems, a HARQ-ACK feedback delay is determined for a corresponding downlink subframe based on an uplink and downlink configuration.

In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios—enhanced mobile broadband (eMBB), massive machine-type communication (mMTC), and ultra-reliable and low-latency communication (URLLC). The eMBB scenario aims to further improve data transmission rate based on the existing mobile broadband service scenario, in order to enhance user experience and provide improved communication experience between people.

mMTC and URLLC are the application scenarios of IoT, but their respective emphases are different. For example, mMTC is mainly for information interaction between people and things, while URLLC mainly reflects communication requirements between things.

In 5G, a UE can support a flexible uplink and downlink frame structure. When a semi-statically configured uplink channel conflicts with semi-statically configured downlink symbols, the UE cancels the transmission of the uplink channel. How to increase the transmission probability of the canceled channel and how to deal with multiplexing and uplink and downlink conflicts for multiple channels that overlap in time domain are problems that need to be addressed.

In order to address at least the above technical problems, embodiments of the disclosure provide a method performed by a terminal, the terminal, a method performed by a BS and the BS in a wireless communication system. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a BS, and the second transceiving node may be a UE. In the following examples, the BS is taken as an example (but not limited thereto) to illustrate the first transceiving node, and the UE is taken as an example (but not limited thereto) to illustrate the second transceiving node.

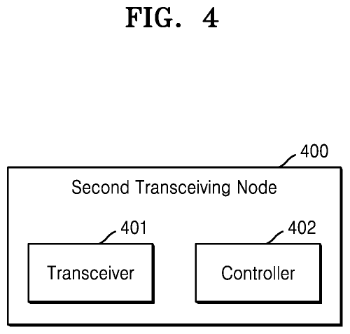

FIG. 4 illustrates a second transceiving node according to an embodiment.

Referring to FIG. 4, the second transceiving node 400 (e.g., a UE) includes a transceiver 401 and a controller 402.

The transceiver 401 may be configured to receive first data and/or first control signaling from a first transceiving node, and transmit second data and/or second control signaling to the first transceiving node in a determined time unit.

The controller 402 may be an application specific integrated circuit (ASIC) or at least one processor. The controller 402 may be configured to control the overall operation of the second transceiving node 400 and control the second transceiving node 400 to implement the methods proposed herein. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

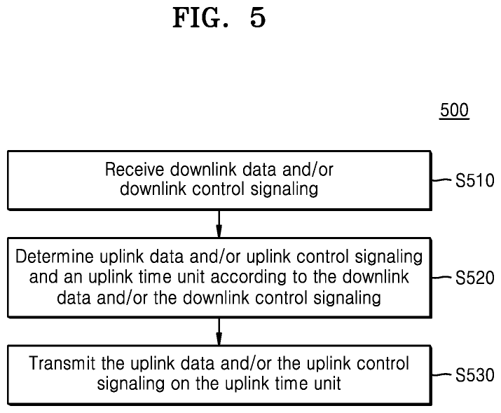

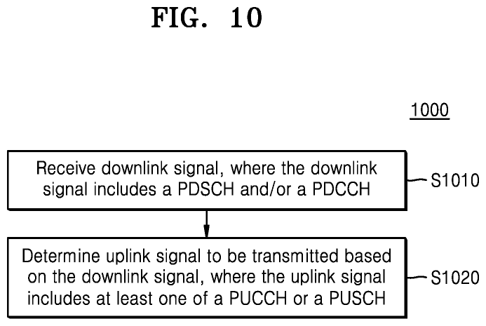

The controller 402 may be configured to perform one or more of the methods of various embodiments described below. For example, the controller 402 may be configured to perform one or more of operations in a method 500 to be described later in connection with FIG. 5 and/or a method 1000 described in connection with FIG. 10.

The first data may be data transmitted by the first transceiving node to the second transceiving node 400. In the following examples, downlink data carried by a PDSCH is taken as an example (but not limited thereto) to illustrate the first data.

The second data may be data transmitted by the second transceiving node 400 to the first transceiving node. In the following examples, uplink data carried by a physical uplink shared channel (PUSCH) is taken as an example to illustrate the second data, but not limited thereto.

The first control signaling may be transmitted by the first transceiving node to the second transceiving node 400. In the following examples, downlink control signaling is taken as an example (but not limited thereto) to illustrate the first control signaling. The downlink control signaling may include downlink control information (DCI) carried by a physical downlink control channel (PDCCH) and/or control signaling carried by a physical downlink shared channel (PDSCH). For example, the DCI may be UE specific DCI or common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

The second control signaling may be transmitted by the second transceiving node 400 to the first transceiving node. In the following examples, uplink control signaling is taken as an example (but is not limited thereto) to illustrate the second control signaling. The uplink control signaling may be uplink control information (UCI) carried by a PUCCH and/or control signaling carried by a physical uplink shared channel (PUSCH). A type of UCI may include one or more of: HARQ-ACK information, scheduling request (SR), link recovery request (LRR), channel state information (CSI), or configured grant (CG) UCI.

A PUCCH with an SR may be a PUCCH with a positive SR and/or a negative SR.

The CSI may also be Part 1 CSI and/or Part 2 CSI.

A first time unit is a time unit in which the first transceiving node transmits the first data and/or the first control signaling. In the following examples, a downlink time unit is taken as an example (but not limited thereto) to illustrate the first time unit.

A second time unit is a time unit in which the second transceiving node 400 transmits the second data and/or the second control signaling. In the following examples, an uplink time unit is taken as an example (but not limited thereto) to illustrate the second time unit.

The first time unit and the second time unit may be one or more slots, one or more subslots, one or more OFDM symbols, or one or more subframes.

Herein, depending on the network type, the term “BS” can refer to any component (or a set of components) configured to provide wireless access to a network, such as a transmission point (TP), a transmission and reception point (TRP), an evolved BS (eNodeB or eNB), a 5G node b (gNB), a macrocell, a femtocell, a WiFi AP, or other wirelessly enabled devices. BSs may provide wireless access in accordance with one or more wireless communication protocols, e.g., 5G 3GPP NR interface/access, LTE, LTE-A, high speed packet access (HSPA), Wi-Fi 802.11a/b/g/n/ac, etc.

Herein, higher layer signaling or higher layer signals include signal transferring methods for transferring information from a BS to a terminal over a downlink data channel of a physical layer or from a terminal to a BS over an uplink data channel of a physical layer. Examples of the signal transferring methods may include signal transferring methods for transferring information via radio resource control (RRC) signaling, packet data convergence protocol (PDCP) signaling, or a medium access control (MAC) control element (CE).

FIG. 5 is a flowchart illustrating a method performed by a UE according to an embodiment.

Referring to FIG. 5, in step S510, the UE receives downlink data and/or downlink control signaling from a BS. For example, the UE may receive the downlink data and/or the downlink control signaling from the BS based on predefined rules and/or received configuration parameters.

In step S520, uplink data and/or uplink control signaling and an uplink time unit are determined based on the downlink data and/or downlink control signaling.

In step S530, the UE transmits the uplink data and/or the uplink control signaling to the BS in an uplink time unit.

Acknowledgement/negative acknowledgement (ACK/NACK) for downlink transmissions may be performed through HARQ-ACK.

The downlink control signaling may include DCI carried by a PDCCH and/or control signaling carried by a PDSCH. For example, the DCI may be used to schedule transmission of a PUSCH or reception of a PDSCH.

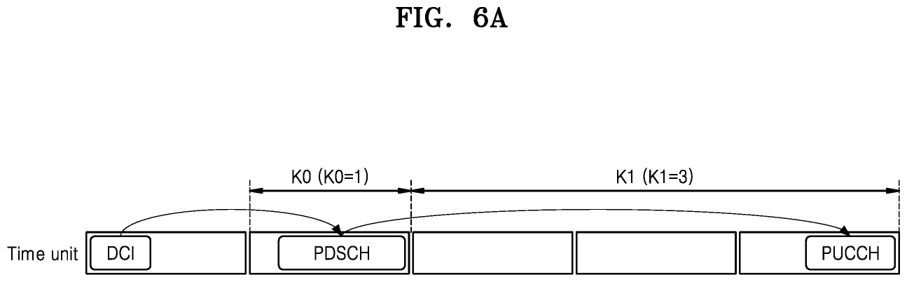

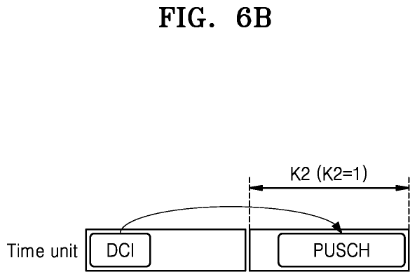

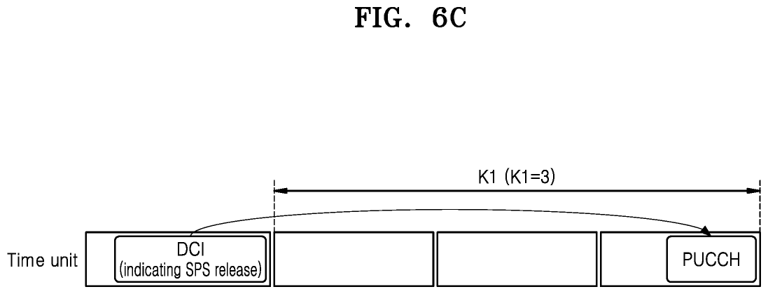

FIGS. 6A-6C illustrate uplink transmission timings according to an embodiment.

Referring to FIG. 6A, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. In the example of FIG. 6A, K0=1 and the time interval from the PDSCH scheduled by the DCI to the PDCCH carrying the DCI is one slot. Herein, the expression “a UE receives DCI” may also mean that “the UE detects the DCI”.

Referring to FIG. 6B, the UE receives the DCI and transmits the PUSCH based on time domain resources indicated by the DCI. For example, a parameter K2 may be used to represent a time interval between the PUSCH scheduled by the DCI and the PDCCH carrying the DCI, and K2 may be in units of slots. In the example of FIG. 6B, K2=1, and the time interval between the PUSCH scheduled by the DCI and the PDCCH carrying the DCI is one slot. K2 may also represent a time interval between a PDCCH for activating a CG PUSCH and the first activated CG PUSCH. Unless otherwise specified herein, the PUSCH may be a PUSCH scheduled by DCI (e.g., a dynamic grant (DG) PUSCH) and/or a PUSCH not scheduled by DCI (e.g., CG PUSCH).

In yet another example, the UE receives the PDSCH, and may transmit HARQ-ACK information for the PDSCH reception in a PUCCH in the uplink time unit. For example, a parameter K1 (e.g., the parameter dl-DataToUL-ACK in 3GPP) may be used to represent a time interval between the PUCCH for transmitting the HARQ-ACK information for the PDSCH reception and the PDSCH, and K1 may be in units of uplink time units, such as slots or subslots. When K1 is in units of slots, the time interval is a value of a slot offset between the PUCCH for feeding back the HARQ-ACK information for the PDSCH reception and the PDSCH. For example, in FIG. 6A, K1=3, and the time interval between the PUCCH for transmitting the HARQ-ACK information for the PDSCH reception and the PDSCH is 3 slots.

The PDSCH may be scheduled by the DCI and/or an SPS PDSCH. The UE will periodically receive the SPS PDSCH after the SPS PDSCH is activated by the DCI. The SPS PDSCH may be equivalent to a PDSCH not scheduled by the DCI/PDCCH. After the SPS PDSCH is released (deactivated), the UE will no longer receive the SPS PDSCH.

Referring to FIG. 6C, the UE receives the DCI (e.g., DCI indicating SPS PDSCH release (deactivation)), and may transmit HARQ-ACK information for the DCI in the PUCCH in the uplink time unit. For example, the parameter K1 may be used to represent a time interval between the PUCCH for transmitting the HARQ-ACK information for the DCI and the DCI, and K1 may be in units of uplink time units, such as slots or subslots. In the example of FIG. 6C, K1=3, and the time interval between the PUCCH for transmitting the HARQ-ACK information for the DCI and the DCI is 3 slots. For example, the parameter K1 may be used to represent a time interval between an SPS PDSCH reception and the PUCCH feeding back HARQ-ACK for the SPS PDSCH reception, where K1 is indicated in DCI activating the SPS PDSCH.

Referring again to FIG. 5, in step S520, the UE may report (or signal/transmit) a UE capability to the BS or indicate the UE capability. For example, the UE reports (or signals/transmits) the UE capability to the BS by transmitting the PUSCH. In this case, the UE capability information is included in the PUSCH transmitted by the UE.

The BS may configure higher layer signaling for the UE based on a UE capability previously received from the UE (e.g., in step S510 in the previous downlink-uplink transmission processes). For example, the BS configures the higher layer signaling for the UE by transmitting the PDSCH. In this case, the higher layer signaling configured for the UE is included in the PDSCH transmitted by the BS. It should be noted that the higher layer signaling is higher layer signaling compared with physical layer signaling, and the higher layer signaling may include RRC signaling and/or a MAC CE.

Downlink channels (or downlink resources) may include PDCCHs and/or PDSCHs. Uplink channels (or uplink resources) may include PUCCHs and/or PUSCHs.

The UE may be configured with two levels of priorities for uplink transmission, e.g., a first priority and a second priority, which is different from the first priority. The first priority may be higher than the second priority, or the first priority may be lower than the second priority. For the sake of convenience, in embodiments of the disclosure, description will be made considering that the first priority is higher than the second priority.

Herein, unicast may refer to a manner in which a network communicates with a UE, and multicast/broadcast may refer to a manner in which a network communicates with multiple UEs. For example, a unicast PDSCH may be received by a UE, and the scrambling of the PDSCH may be based on a radio network temporary identifier (RNTI) specific to the UE, e.g., a cell-RNTI (C-RNTI). The unicast PDSCH may also be a unicast SPS PDSCH. A multicast/broadcast PDSCH may be a PDSCH received by more than one UE simultaneously, and the scrambling of the multicast/broadcast PDSCH may be based on a UE-group common RNTI. For example, the UE-group common RNTI for scrambling the multicast/broadcast PDSCH may include an RNTI (referred to as a group-RNTI (G-RNTI) herein) for scrambling of a dynamically scheduled multicast/broadcast transmission (e.g., PDSCH) or an RNTI (referred to as a group configured scheduling RNTI (G-CS-RNTI) herein) for scrambling of a multicast/broadcast SPS transmission (e.g., an SPS PDSCH). The G-CS-RNTI and the G-RNTI may be different RNTIs or same RNTI.

UCI(s) of the unicast PDSCH may include HARQ-ACK information, SR, or CSI for the unicast PDSCH reception. UCI(s) of the multicast (or groupcast)/broadcast PDSCH may include HARQ-ACK information for the multicast/broadcast PDSCH reception. Herein, “multicast/broadcast” may refer to at least one of multicast or broadcast.

A HARQ-ACK codebook may include HARQ-ACK information for one or more PDSCHs and/or DCI. If the HARQ-ACK information for the one or more PDSCHs and/or DCI is transmitted in a same uplink time unit, the UE may generate the HARQ-ACK codebook based on a predefined rule. For example, if a PDSCH is successfully decoded, the HARQ-ACK information for this PDSCH reception is positive ACK. The positive ACK may be represented by 1 in the HARQ-ACK codebook, for example. If a PDSCH is not successfully decoded, the HARQ-ACK information for this PDSCH reception is NACK. NACK may be represented by 0 in the HARQ-ACK codebook, for example.

The UE may generate the HARQ-ACK codebook based on the pseudo code specified by protocols. For example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook in 3GPP) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI.

In yet another example, if the UE receives a DCI format that schedules a PDSCH, the UE transmits HARQ-ACK information for the PDSCH reception. In yet another example, the UE receives an SPS PDSCH, and the UE transmits HARQ-ACK information for the SPS PDSCH reception. In yet another example, if the UE is configured by higher layer signaling to receive an SPS PDSCH, the UE transmits HARQ-ACK information for the SPS PDSCH reception. The reception of the SPS PDSCH configured by higher layer signaling may be cancelled by other signaling.

In yet another example, if at least one uplink symbol (e.g., OFDM symbol) of the UE in a semi-static frame structure configured by higher layer signaling overlaps with a symbol of an SPS PDSCH, the UE does not receive the SPS PDSCH. In yet another example, if the UE is configured by higher layer signaling to receive an SPS PDSCH according to a predefined rule, the UE transmits HARQ-ACK information for the SPS PDSCH reception. Herein, the expression “‘A’ overlaps with ‘B”’ may mean that ‘A’ at least partially overlaps with ‘B’ or ‘A’ completely overlaps with ‘B’. The expression “‘A’ overlaps with ‘B”’ may also mean that ‘A’ overlaps with ‘B’ in time domain and/or ‘A’ overlaps with ‘B’ in frequency domain.

In some implementations, if HARQ-ACK information transmitted in a same uplink time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same uplink time unit only includes HARQ-ACK information for one or more SPS PDSCH receptions, the UE may generate HARQ-ACK information according to a rule for generating a HARQ-ACK codebook for an SPS PDSCH reception.

If HARQ-ACK information transmitted in a same uplink time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook in 3GPP) or a dynamic HARQ-ACK codebook (e.g., Type-2 HARQ-ACK codebook in 3GPP) according to a PDSCH HARQ-ACK codebook configuration parameter (e.g., the parameter pdsch-HARQ-ACK-Codebook in 3GPP). The dynamic HARQ-ACK codebook may also be an enhanced dynamic HARQ-ACK codebook (e.g., Type-2 HARQ-ACK codebook based on grouping and HARQ-ACK retransmission in 3GPP).

If HARQ-ACK information transmitted in a same uplink time unit includes only HARQ-ACK information for an SPS PDSCH (e.g., a PDSCH not scheduled by a DCI format), the UE may generate the HARQ-ACK codebook according to a rule for generating a HARQ-ACK codebook for an SPS PDSCH reception (e.g., the pseudo code for generating a HARQ-ACK codebook for an SPS PDSCH reception defined in 3GPP).

The dynamic HARQ-ACK codebook and/or the enhanced dynamic HARQ-ACK codebook may determine a size and an order of the HARQ-ACK codebook according to an assignment indicator. For example, the assignment indicator may be a downlink assignment indicator DAI). Herein, the assignment indicator as the DAI is taken as an example for illustration. However, the embodiments of the disclosure are not limited thereto, and any other suitable assignment indicator may be adopted.

A DAI field includes at least one of a first DAI and a second DAI.

The first DAI may be a counter-DAI (C-DAI. The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. The C-DAI may refer to:
an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy));
an accumulative number of PDCCH(s) up to the current time unit;
an accumulative number of PDSCH transmission(s) up to the current time unit;
an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a BS up to the current serving cell and/or the current time unit;
an accumulative number of PDSCHs (the PDSCHs are PDSCHs with corresponding PDCCHs) already scheduled by the BS up to the current serving cell and/or the current time unit; or
an accumulative number of time units with PDSCH transmissions (the PDSCHs are PDSCHs with corresponding PDCCHs) already scheduled by the BS up to the current serving cell and/or the current time unit.

The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

The second DAI may be a total-DAI (T-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. T-DAI may refer to:
a total number of (serving cell, time unit) pairs scheduled by PDCCH(s) up to the current time unit within a time window (which may also include a number of PDCCHs for indicating SPS release);
a total number of PDSCH transmissions up to the current time unit;
a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a BS up to the current serving cell and/or the current time unit;
a total number of PDSCHs (the PDSCHs are PDSCHs with corresponding PDCCHs) already scheduled by the BS up to the current serving cell and/or the current time unit; or
a total number of time units with PDSCH transmissions (e.g., the PDSCHs are PDSCHs with corresponding PDCCHs) already scheduled by the BS up to the current serving cell and/or the current time unit.

The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m}. Numbers of bits of the C-DAI and T-DAI are limited.

When the C-DAI or T-DAI is represented with 2 bits, the value of the C-DAI or T-DAI in the DCI may be determined by the equations in Table 1. V_{T-DAI,m} is the value of the T-DAI in DCI received in a PDCCH monitoring occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| MSB, LSB of | V_{T-DAI, m} or | |
|---|---|---|
| DAI Field | V_{C-DAI, c, m} | Y |
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

When the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the BS (the value of the DAI before conversion by the equation in Table 1).

When the C-DAI or T-DAI in the DCI is 1 bit, values greater than 2 may be represented by the equations in Table 2.

TABLE 2

| | V_{T-DAI, m} or | |
|---|---|---|
| DAI field | V_{C-DAI, c, m} | Y |
| 0 | 1 | (Y − 1) mod 2 + 1 = 1 |
| 1 | 2 | (Y − 1) mod 2 + 1 = 2 |

Unless the context clearly indicates otherwise, all or one or more of the methods, steps and operations described in embodiments of the disclosure may be specified by protocols and/or configured by higher layer signaling and/or indicated by dynamic signaling. The dynamic signaling may be a PDCCH and/or DCI and/or a DCI format. For example, for an SPS PDSCH and/or a CG PUSCH, it may be dynamically indicated in active DCI/DCI format/PDCCH for the SPS PDSCH and/or the CG PUSCH. All or one or more of the described methods, steps and operations may be optional. For example, if a certain parameter (e.g., parameter X) is configured, the UE performs a certain approach (e.g., approach A), otherwise (if the parameter is not configured, e.g., parameter X), the UE performs another approach (e.g., approach B).

Herein, a primary cell (PCell) or a primary secondary cell (PSCell) may be used interchangeably with a cell having a PUCCH.

Methods for downlink in the disclosure may also be applicable to uplink, and methods for uplink may also be applicable to downlink. For example, a PDSCH may be replaced with a PUSCH, an SPS PDSCH may be replaced with a CG PUSCH, and downlink symbols may be replaced with uplink symbols, so that methods for downlink may also be applicable to uplink.

Methods applicable to multiple PDSCH/PUSCH scheduling in the disclosure may also be applicable to a PDSCH/PUSCH transmission with repetitions. For example, a PDSCH/PUSCH of multiple PDSCH/PUSCHs may be replaced by a repetition of multiple repetitions of the PDSCH/PUSCH transmission.

In methods of the disclosure, a PDCCH and/or DCI and/or a DCI format schedule multiple PDSCHs/PUSCHs, which may be multiple PDSCHs/PUSCHs of a same serving cell and/or multiple PDSCHs/PUSCHs of different serving cells.

The multiple approaches described herein may be combined in any order. In a combination, an approach may be performed one or more times.

The steps in the methods of the disclosure may be implemented in different orders.

In methods of the disclosure, “canceling a transmission” may mean canceling the transmission of the entire uplink channel and/or cancel the transmission of a part of the uplink channel.

In methods of the disclosure, “not transmitting” may be replaced by “canceling a transmission”.

In methods of the disclosure, “multiplexing A in PUCCH/PUSCH” may mean that a UE transmits the PUCCH/PUSCH.

In methods of the disclosure, the method of “multiplexing” may also be applicable to “prioritization” and the method of “prioritization” may also be applicable to “multiplexing”.

In communication systems (e.g., TDD systems), when one or more symbols in an uplink time unit are configured as downlink by higher layer signaling, or one or more symbols in the uplink time unit are indicated as downlink by dynamic signaling, if an uplink resource (e.g., the uplink resource may be a PUCCH and/or a PUSCH) including/carrying/with HARQ-ACK information only for SPS PDSCH reception(s) (i.e., HARQ-ACK information corresponding to only SPS PDSCH receptions) in the uplink time unit overlaps with the downlink symbol and/or flexible symbol, and the UE cannot transmit the HARQ-ACK information only for the SPS PDSCH reception(s). The UE may defer (e.g., delay) the transmission of the HARQ-ACK information only for the SPS PDSCH reception(s) to the first and/or next available uplink resource for transmission. Alternatively, the UE may cancel the transmission of the HARQ-ACK information only for the SPS PDSCH reception(s). How to determine whether the transmission of the HARQ-ACK information only for the SPS PDSCH reception(s) is cancelled or deferred is a problem to be addressed.

In some implementations, it may be specified by protocols and/or configured by higher layer signaling that, if a first PUCCH with HARQ-ACK information only for SPS PDSCH receptions overlaps with one or more uplink channels (e.g., the uplink channels may include PUCCH and/or PUSCH; and for another example, physical layer priorities of the one or more uplink channels and the first PUCCH may be the same or different) in time domain, multiplexing and/or prioritization is performed for the first PUCCH and the one or more uplink channels. A result of the multiplexing and/or prioritization of the one or more uplink channels and the first PUCCH may be at least one determined uplink channel (e.g., for convenience of description, it may be referred to as resulting uplink channel). For the sake of conciseness, in the description of embodiments of the disclosure, one resulting uplink channel is taken as an example for illustration, however, after a little modification, the embodiments of the disclosure are also applicable to multiple resulting uplink channels. For example, the determined uplink channel (e.g., the resulting uplink channel) may include an uplink channel for multiplexing that is determined from among the first PUCCH and the one or more uplink channels or an uplink channel satisfying a priority condition (e.g., with the highest priority) that is determined from among the first PUCCH and the one or more uplink channels. The multiplexing and/or prioritization may be performed based on any suitable methods (e.g., the methods described in some embodiments, or the methods defined in 3GPP), and are not limited thereto. After the resulting uplink channel is determined, whether the HARQ-ACK information only for the SPS PDSCH receptions is deferred and/or cancelled may be determined by at least one of the following approaches MN1˜MN4.

Approach MN1 (i.e., a first approach)

In approach MN1, if the determined uplink channel (e.g., the resulting uplink channel) as the result of multiplexing and/or prioritization of the first PUCCH with the HARQ-ACK information only for the SPS PDSCH receptions and the multiple uplink channels is a PUCCH resource (e.g., a PUCCH resource configured by 3GPP parameters SPS-PUCCH-AN-List-r16 and/or n1PUCCH-AN, which may carry the HARQ-ACK information only for the SPS PDSCH receptions and/or SR information) for carrying the HARQ-ACK information only for the SPS PDSCH receptions which is configured by higher layer signaling, and the determined uplink channel (e.g., the resulting uplink channel) satisfies a predefined condition COND1 (herein, it may also be referred to as a first predefined condition or a first transmission condition), then the UE may defer the HARQ-ACK information only for the SPS PDSCH receptions to/until the next uplink resource (e.g., an uplink resource in the next slot/subslot) for transmission. The predefined condition COND1 may include that the determined uplink channel (e.g., the resulting uplink channel) (e.g., PUCCH) overlaps with at least one first predefined time unit (for example, the time unit may include a slot, a subslot, a symbol, or a subframe). For the convenience of description, a first predefined symbol is taken as an example. Each of the at least one first predefined symbol may include a downlink symbol configured (semi-statically configured) by higher layer signaling and/or a symbol occupied by a synchronization signal block (SSB)/CORESET0 (a CORESET of Type 0-PDCCH common search space (CSS)). Each of the at least one first predefined symbol may also include a predefined symbol defined in other examples of the disclosure (e.g., a second predefined time unit (e.g., the time unit may include a slot, a subslot, a symbol, or a subframe). If the determined uplink channel (e.g., the resulting uplink channel) is not the first PUCCH for carrying the HARQ-ACK information only for the SPS PDSCH receptions (e.g., the determined uplink channel (e.g., the resulting uplink channel) is another PUCCH or PUSCH other than (or not overlapping with) the first PUCCH; and for another example, the first PUCCH with the HARQ-ACK information only for the SPS PDSCH receptions is multiplexed in the determined uplink channel (e.g., the resulting uplink channel) with other PUCCHs and/or PUSCHs), the UE may not defer the HARQ-ACK information only for the SPS PDSCH receptions to/until the next uplink resource (e.g., the uplink resource in the next slot/subslot) for transmission.

It may be specified by protocols and/or configured by higher layer signaling to determine whether the UE transmits the determined uplink channel (e.g., the resulting uplink channel). If the determined uplink channel (e.g., the resulting uplink channel) can be transmitted, the HARQ-ACK information only for the SPS PDSCH receptions can be transmitted. However, if the determined uplink channel (e.g., the resulting uplink channel) cannot be transmitted, the HARQ-ACK information only for the SPS PDSCH receptions cannot be transmitted. For example, when the determined uplink channel (e.g., the resulting uplink channel) satisfies a predefined condition COND2 (herein, it may also be referred to as a second predefined condition or a second transmission condition), the UE transmits the determined uplink channel (e.g., the resulting uplink channel). When the determined uplink channel (e.g., the resulting uplink channel) does not satisfy the predefined condition COND2, the UE does not transmit the determined uplink channel (e.g., the resulting uplink channel). The predefined condition COND2 may be determined according to the methods specified in 3GPP, e.g., the condition that the uplink channel may be transmitted. The method determines whether to defer the transmission of the HARQ-ACK information only for the SPS PDSCH receptions according to the multiplexed and/or prioritized uplink resource, which clarifies the behavior of the UE and can improve the reliability of the uplink transmission.

According to approach MN1, if the first PUCCH with the HARQ-ACK information only for the SPS PDSCH receptions overlaps with a PUCCH with SR in time domain, the HARQ-ACK information only for the SPS PDSCH receptions and the SR may be multiplexed in a PUCCH. If the multiplexed PUCCH satisfies the predefined condition COND1, the UE may defer the HARQ-ACK information only for the SPS PDSCH receptions to/until the next uplink resource (e.g., the uplink resource in the next slot/subslot) for transmission. It may be specified by protocols and/or configured by higher layer signaling that, the UE does not transmit the PUCCH with the SR. Alternatively, it may be specified by protocols and/or configured by higher layer signaling that, when the PUCCH with the SR satisfies the predefined condition COND2, the UE transmits the PUCCH with the SR. The predefined condition COND2 may include that the PUCCH with the SR does not overlap with other uplink channels, and/or that the PUCCH with the SR does not overlap with downlink symbol(s) indicated by higher layer signaling and/or a dynamic slot format indicator (SFI). For example, if the PUCCH with the SR does not overlap with other uplink channels, and the PUCCH does not overlap with the downlink symbol(s) indicated by the higher layer signaling and/or dynamic SFI, the UE transmits the PUCCH with the SR; otherwise, the UE does not transmit the PUCCH with the SR. This method can increase the opportunity for SR transmission and reduce the delay of the uplink control plane.

It may be specified by protocols and/or configured by higher layer signaling that the PUCCH resource (e.g., the PUCCH resource configured by the 3GPP parameters SPS-PUCCH-AN-List-r16 and/or n1PUCCH-AN, which may carry the HARQ-ACK information only for the SPS PDSCH receptions and/or the SR information) for carrying the HARQ-ACK information only for the SPS PDSCH receptions, which is configured by higher layer signaling in approach MN1, may be a PUCCH resource with the same priority (e.g., physical layer priority) as the first PUCCH with the HARQ-ACK information only for the SPS PDSCH receptions.

Alternatively, it may be specified by protocols and/or configured by higher layer signaling that the PUCCH resource configured by higher layer signaling for carrying the HARQ-ACK information only for the SPS PDSCH receptions in approach MN1 may be a PUCCH resource with the same priority (e.g., physical layer priority) as the first PUCCH with the HARQ-ACK information only for the SPS PDSCH receptions, and/or a PUCCH resource with a different priority (e.g., physical layer priority) than the first PUCCH with the HARQ-ACK information only for the SPS PDSCH receptions. The method can increase the transmission probability of the HARQ-ACK information for SPS PDSCH reception with a lower priority and improve the reliability of the HARQ-ACK transmission.

Approach MN2 (i.e., a second approach)

In approach MN2, if the determined uplink channel (e.g., the resulting uplink channel) as the result of multiplexing and/or prioritization of the first PUCCH with the HARQ-ACK information only for the SPS PDSCH receptions and the multiple uplink channels is the first PUCCH with the HARQ-ACK information only for the SPS PDSCH receptions (e.g., the determined uplink channel (e.g., the resulting uplink channel) is not multiplexed with other PUCCHs and/or is not cancelled by other uplink channels), and the determined uplink channel (e.g., the resulting uplink channel) satisfies the predefined condition COND1, the UE may defer the HARQ-ACK information only for the SPS PDSCH receptions to/until the next uplink resource (e.g., the uplink resource in the next slot/subslot) for transmission. If the determined uplink channel (e.g., the resulting uplink channel) is not the first PUCCH with the HARQ-ACK information only for the SPS PDSCH receptions (e.g., the first PUCCH with the HARQ-ACK information only for the SPS PDSCH receptions is multiplexed in the determined uplink channel (e.g., the resulting uplink channel) with other PUCCHs and/or PUSCHs), the UE may not defer the HARQ-ACK information only for the SPS PDSCH receptions to/until the next uplink resource (e.g., the uplink resource in the next slot/subslot) for transmission.

It may be specified by protocols and/or configured by higher layer signaling that the UE determines whether to transmit the determined uplink channel (e.g., the resulting uplink channel). If the determined uplink channel (e.g., the resulting uplink channel) can be transmitted, the HARQ-ACK information only for the SPS PDSCH receptions can be transmitted. However, if the determined uplink channel (e.g., the resulting uplink channel) cannot be transmitted, the HARQ-ACK information only for the SPS PDSCH receptions cannot be transmitted. For example, when the determined uplink channel (e.g., the resulting uplink channel) satisfies the predefined condition COND2, the UE transmits the determined uplink channel (e.g., the resulting uplink channel). When the determined uplink channel (e.g., the resulting uplink channel) does not satisfy the predefined condition COND2, the UE does not transmit the determined uplink channel (e.g., the resulting uplink channel).

The method determines whether to defer the transmission of the HARQ-ACK information only for the SPS PDSCH receptions according to whether the PUCCH with the HARQ-ACK information only for the SPS PDSCH receptions is multiplexed with other uplink channels and/or prioritized with other uplink channels. In this way, the behavior of the UE is clarified, and the reliability of the uplink transmission can be improved.

Approach MN3 (i.e., a third approach)

In approach MN3, if the first PUCCH with the HARQ-ACK information only for the SPS PDSCH receptions is cancelled by other channels (e.g., the determined uplink channel (e.g., the resulting uplink channel) does not carry (contain) the HARQ-ACK information only for the SPS PDSCH receptions), and the first PUCCH with the HARQ-ACK information only for the SPS PDSCH receptions satisfies the predefined condition COND1 as described in approach MN1 (i.e., overlaps with at least one first predefined symbol), the UE may defer the HARQ-ACK information only for the SPS PDSCH receptions to/until the next uplink resource (e.g., the uplink resource in the next slot/subslot) for transmission. The method can improve the transmission probability of the HARQ-ACK information only for the SPS PDSCH receptions and improve the reliability of the HARQ-ACK transmission.

Approach MN4 (i.e., a fourth approach)

In approach MN4, if the first PUCCH with the HARQ-ACK information only for the SPS PDSCH receptions is cancelled by other channels (the determined uplink channel (e.g., the resulting uplink channel) does not carry (contain) the HARQ-ACK information only for the SPS PDSCH receptions), the UE may not defer the HARQ-ACK information only for the SPS PDSCH receptions to/until the next uplink resource (e.g., the uplink resource in the next slot/subslot) for transmission. The method is simple to implement, and can reduce the complexity implementation of the UE and BS.

In some cases, HARQ-ACK information only for SPS PDSCH reception(s) in a time unit (e.g., slot/subslot) may be deferred to/until another time unit, in which there may be other HARQ-ACK information only for the SPS PDSCH reception(s) (e.g., HARQ-ACK information only for the SPS PDSCH reception(s) that is not deferred). In these cases, how to determine whether the transmission of the HARQ-ACK information only for the SPS PDSCH reception(s) in the other time unit is cancelled and/or deferred is a problem to be addressed. Whether the HARQ-ACK information only for the SPS PDSCH reception(s) is deferred and/or cancelled may be determined through the following approaches.

If there is HARQ-ACK information only for SPS PDSCH receptions that are deferred and HARQ-ACK information only for SPS PDSCH receptions that are not deferred in a time unit, it may be specified by protocols and/or configured by higher layer signaling that, the HARQ-ACK information only for the SPS PDSCH receptions that are deferred and the HARQ-ACK information only for the SPS PDSCH receptions that are not deferred are multiplexed in a PUCCH, and then whether the HARQ-ACK information only for the SPS PDSCH receptions in the multiplexed PUCCH are deferred and/or is transmitted is determined according to other examples of the disclosure. The method is simple to implement, and can deal with the problem in the scenario where there is HARQ-ACK information only for the SPS PDSCH reception(s) that is deferred in a time unit.

In examples of the disclosure, the HARQ-ACK information only for the SPS PDSCH reception(s) may be HARQ-ACK information only for SPS PDSCH reception(s) that are not deferred in the current time unit. Alternatively, the HARQ-ACK information only for the SPS PDSCH reception(s) may be HARQ-ACK information only for SPS PDSCH reception(s) that are not deferred in the current time unit and/or HARQ-ACK information only for SPS PDSCH reception(s) in other time units that are deferred to/until the current time unit.

For an SPS PDSCH configuration, it may be considered to enable or disable deferral of transmission of HARQ-ACK information only for SPS PDSCH reception(s).

Whether HARQ-ACK information only for SPS PDSCH receptions may be deferred may be enabled or disabled for each SPS PDSCH configuration by higher layer signaling. If an SPS PDSCH configuration is not configured by higher layer signaling to allow deferral of transmission of HARQ-ACK information, the transmission of the HARQ-ACK information for the SPS PDSCH reception for the SPS PDSCH configuration may not be deferred to/until the next available uplink resource. An SPS PDSCH configuration that allows deferral of transmission of HARQ-ACK information may also be configured with a maximum deferral transmission time unit parameter K1′ by higher layer signaling, where K1′ is a non-negative integer. The parameter K1′ is a maximum time unit interval between actual transmitted HARQ-ACK information for an SPS PDSCH reception and the SPS PDSCH reception. For example, when an SPS PDSCH configuration is configured by higher layer signaling to allow deferral of transmission of HARQ-ACK information, if a time unit interval between a PUCCH with the HARQ-ACK information for an SPS PDSCH reception for the SPS PDSCH configuration in the current time unit and the SPS PDSCH reception is less than the maximum deferral transmission time unit parameter K1′, and the PUCCH satisfies a predefined condition (e.g., the predefined condition COND1 in examples of the disclosure), then the transmission of the HARQ-ACK information for the SPS PDSCH reception may be deferred to/until the next available uplink resource. If the time unit interval between the PUCCH with the HARQ-ACK information for the SPS PDSCH reception for the SPS PDSCH configuration in the current time unit and the SPS PDSCH reception is not less than the maximum deferral transmission time unit parameter K1′, the transmission of the HARQ-ACK information for the SPS PDSCH reception may not be deferred to/until the next available uplink resource.

If the maximum deferral transmission time unit parameter K1′ is not configured by higher layer signaling, a default parameter K1′ may also be specified by protocols. For example, the default parameter K1′ may be a maximum value in a set of parameters K1 (e.g., the set of K1 may be a union of sets of K1 corresponding to multiple DCI formats; and for the definition of the parameter K1, please refer to the previous description). Alternatively, it is specified by protocols that the UE does not expect that an SPS PDSCH configuration that enables deferral of transmission of HARQ-ACK information is not configured with the maximum deferral transmission time unit parameter by higher layer signaling. In this way, the behavior of the UE can be clarified, and the reliability of the uplink transmission can be improved.

A time unit of the parameter K1′ may be at least one of:
a time unit of the current active uplink bandwidth part (BWP) of a serving cell of the PUCCH;
an absolute time, e.g., milliseconds;
a time unit of a default (or initially accessed) uplink BWP; or
a specific time unit, e.g., a parameter of the specific time unit may be configured in a configuration parameter for SPS PDSCHs (e.g., 3GPP parameter SPS-Config).

If the time unit of the parameter K1′ is different from the time unit of the current active uplink BWP of the serving cell (e.g., Pcell) of the PUCCH, a converted K1′ may be determined by a predefined method. For example, assuming that a time unit length of K1′ is T1, and a time unit length of the current active uplink BWP of the serving cell of the PUCCH is T2, the converted K1′ may be determined as └K1′×T1÷T2┘ or ┌K1′×T1÷T2┐. The method defines the determination method of K1′, so that the UE and the BS can keep the understanding of the delay time consistent, and the reliability of the HARQ-ACK transmission can be improved.

When HARQ-ACK information for multiple SPS PDSCH receptions is determined to be transmitted in a time unit, there is a case where a transmission of HARQ-ACK information for a part of the SPS PDSCH receptions may be deferred to/until the next available uplink resource when a predefined condition is satisfied, while a transmission of HARQ-ACK information for another part of the SPS PDSCH receptions may not be deferred to/until the next available uplink resource. In this case, how to determine whether the HARQ-ACK information for each SPS PDSCH reception is transmitted in the current time unit and/or deferred is a problem to be addressed.

The multiple SPS PDSCH receptions or the HARQ-ACK information for the multiple SPS PDSCH receptions may be divided into two sets including a first set and a second set. The first set may correspond to deferral of the transmission of the HARQ-ACK information for the SPS PDSCH reception being allowed, and the second set may correspond to the deferral of the transmission of the HARQ-ACK information for the SPS PDSCH reception being not allowed. For example, the first set may contain an SPS PDSCH reception/HARQ-ACK information for the SPS PDSCH reception for which transmission of the HARQ-ACK information for the SPS PDSCH reception may be deferred to/until the next available uplink resource when a predefined condition (e.g., the predefined conditions defined in other examples of the disclosure) is satisfied. The second set may contain an SPS PDSCH reception/HARQ-ACK information for the SPS PDSCH reception for which transmission of the HARQ-ACK information for the SPS PDSCH reception may not be deferred to/until the next available uplink resource. For example, the first set may contain an SPS PDSCH for which an SPS PDSCH configuration is configured with enabling deferral of transmission of HARQ-ACK information, and/or for which a time unit interval between a PUCCH with the HARQ-ACK information for the SPS PDSCH reception and the SPS PDSCH reception is less than the maximum deferral transmission time unit parameter K1′. The second set may contain an SPS PDSCH for which an SPS PDSCH configuration is not configured with enabling deferral transmission of HARQ-ACK information, and/or for which the SPS PDSCH configuration is configured with enabling deferral of the transmission of HARQ-ACK information and a time unit interval between a PUCCH with HARQ-ACK information for SPS PDSCH reception and the SPS PDSCH reception is not less than the maximum deferral transmission time unit parameter K1′.

Whether HARQ-ACK information only for SPS PDSCH reception(s) is deferred and/or cancelled may be determined through at least one of the following approaches MN5 or MN6.

Approach MN5 (i.e., a fifth approach)

It may be specified by protocols and/or configured by higher layer signaling that the UE does not expect that UCI that can be deferred (e.g., UCI which can be deferred may be HARQ-ACK corresponding to the first set) and UCI which cannot be deferred (e.g., the UCI which cannot be deferred may be HARQ-ACK and/or SR and/or CSI corresponding to the second set) are multiplexed in a PUCCH. For example, the UE does not expect that HARQ-ACK information for an SPS PDSCH reception in the first set and HARQ-ACK information for an SPS PDSCH reception in the second set are transmitted in a same time unit. For example, the UE does not expect that HARQ-ACK information for an SPS PDSCH reception for an SPS PDSCH configuration that allows deferral of transmission of the HARQ-ACK information and HARQ-ACK information for an SPS PDSCH reception for an SPS PDSCH configuration that disables deferral of transmission of the HARQ-ACK information are transmitted in a same time unit. The method is simple to implement and can reduce the implementation complexity of the UE.

Approach MN6 (i.e., a sixth approach)

It may be specified by protocols and/or configured by higher layer signaling that, if an uplink channel includes UCI which can be deferred and UCI which cannot be deferred, and the uplink channel satisfies a condition for deferral transmission (e.g., the above predefined condition COND1), the UE defers transmission of the UCI that can be deferred to/until the next available uplink resource. The UE does not transmit the UCI that cannot be deferred; or, if a PUCCH with the UCI which cannot be deferred satisfies a predefined transmission condition (e.g., the predefined condition COND2), the UE transmits the PUCCH with the UCI that cannot be deferred. For example, when there are HARQ-ACK information for at least one SPS PDSCH reception for the SPS PDSCH configuration in the first set and HARQ-ACK information for at least one SPS PDSCH reception for the SPS PDSCH configuration in the second set in a time unit, if it is determined that HARQ-ACK information only for SPS PDSCH receptions may be deferred according to a predefined condition (e.g., the conditions defined in other examples of the disclosure), the UE defers transmission of the HARQ-ACK information for the SPS PDSCH reception in the first set to/until the next available uplink resource. The UE does not transmit the HARQ-ACK information for the SPS PDSCH reception in the second set.

Alternatively, when a PUCCH with HARQ-ACK information only for SPS PDSCH receptions in the second set satisfies the predefined condition COND2, the UE transmits the HARQ-ACK information for the SPS PDSCH reception in the second set. For example, when there is HARQ-ACK information for at least one SPS PDSCH reception for the SPS PDSCH configuration that allows the deferral of the transmission of the HARQ-ACK information and HARQ-ACK information for at least one SPS PDSCH reception for the SPS PDSCH configuration that disables the deferral of the transmission of the HARQ-ACK information in a time unit, if it is determined that the HARQ-ACK information only for the SPS PDSCH receptions may be deferred according to a predefined condition (e.g., predefined conditions in other examples of the disclosure), the UE defers the transmission of the HARQ-ACK information for the SPS PDSCH reception for the SPS PDSCH configuration that allows the deferral of the transmission of the HARQ-ACK information to/until the next available uplink resource. The UE does not transmit the HARQ-ACK information for the SPS PDSCH reception for the SPS PDSCH configuration that disables the deferral of the transmission of the HARQ-ACK information.

Alternatively, when a PUCCH of the HARQ-ACK information for the SPS PDSCH reception for the SPS PDSCH configuration that disables the deferral of the transmission of the HARQ-ACK information satisfies the predefined condition COND2, the UE transmits the HARQ-ACK information for the SPS PDSCH reception for the SPS PDSCH configuration that disables the deferral of the transmission of the HARQ-ACK information. The method can increase the transmission probability of the HARQ-ACK, SR and CSI for the SPS PDSCH reception, and can improve the reliability of the uplink transmission.

A PUCCH transmission may be configured with repetitions. It may be specified by protocols and/or configured by higher layer signaling that the UE does not expect that a number of repetitions in each of all PUCCH resources in the 3GPP parameter SPS-PUCCH-AN-List-r16 is different. This is simple to implement, which can reduce the implementation complexity of the UE and the BS.

When a PUCCH transmission is configured with repetitions, how to determine whether HARQ-ACK information only for SPS PDSCH reception(s) is cancelled and/or deferred is a problem to be addressed. Whether the transmission of the HARQ-ACK information only for the SPS PDSCH reception(s) is deferred and/or cancelled may be determined by at least one of the following approaches MN7 to MN9.

Approach MN7 (i.e., a seventh approach)

In approach MN7, it may be specified by protocols and/or configured by higher layer signaling that, if the HARQ-ACK information only for the SPS PDSCH receptions carried by at least N1 (N1 is a positive integer, and N1 may be specified by protocols and/or configured by higher layer signaling; e.g., N1 may be 1) PUCCH repetitions of multiple repetitions of the PUCCH transmission may be transmitted (e.g., it may be transmitted through the PUCCH with the HARQ-ACK information only for the SPS PDSCH receptions and/or multiplexed in other PUCCHs for transmission and/or multiplexed in a PUSCH for transmission), the UE does not defer the transmission of the HARQ-ACK information only for the SPS PDSCH receptions. If the HARQ-ACK information only for the SPS PDSCH receptions carried by all of the multiple repetitions of the PUCCH transmission cannot be transmitted (e.g., it is determined to be cancelled by a predefined condition (e.g., the predefined conditions described in examples of the disclosure)), and/or at least N2 (N2 is a positive integer, and N2 may be specified by protocols and/or configured by higher layer signaling; e.g., N2 may be 1) repetitions of the multiple repetitions of the PUCCH transmission may be determined by a predefined condition (e.g., the predefined conditions described in examples of the disclosure) to defer the transmission of the HARQ-ACK information only for the SPS PDSCH receptions, then the UE may defer the HARQ-ACK information only for the SPS PDSCH receptions to/until the next uplink resource (e.g., the uplink resource in the next slot/subslot) for transmission. The method clarifies the behavior of the UE, which can ensure the understanding consistency between the UE and the BS and improve the reliability of the uplink transmission.

Approach MN8 (i.e., an eighth approach)

It may be specified by protocols and/or configured by higher layer signaling that the UE does not expect to be configured with a PUCCH transmission with repetitions (e.g., slot based repetitions and/or subslot based repetitions) (e.g., a PUCCH with the HARQ-ACK only for the SPS PDSCH reception(s); e.g., any PUCCH resource carrying the HARQ-ACK only for the SPS PDSCH reception(s)) and configured with enabling deferral of the transmission of the HARQ-ACK information only for the SPS PDSCH reception(s) (e.g., allowing deferral of the transmission of the HARQ-ACK information for any SPS PDSCH configuration) at the same time. The method is simple to implement and can reduce the implementation complexity of the UE and the BS.

Approach MN43 (i.e., a forty-third approach)

It may be specified by protocols and/or configured by higher layer signaling that, for a given priority, the UE does not expect to be configured with a PUCCH transmission (e.g., all PUCCH resources or all PUCCH resources with the priority) with repetitions (e.g., slot based repetitions and/or subslot based repetitions) and configured with allowing deferral of the transmission of the HARQ-ACK information only for the SPS PDSCH reception(s)(e.g., allowing deferred transmission of the HARQ-ACK information for any SPS PDSCH configuration, and the UE is configured with the 3GPP parameter spsHARQdeferral) at the same time. The method is simple to implement and can reduce the implementation complexity of the UE and the BS. The method may not affect PUCCH resource configurations with other priorities, and can improve the scheduling flexibility.

Approach MN44 (i.e., a forty-fourth approach)

It may be specified by protocols and/or configured by higher layer signaling that, if the UE is configured with two priorities (e.g., the UE is configured with two 3GPP parameters PUCCH-Config), the UE does not expect to be configured with a PUCCH transmission (e.g., all PUCCH resources or all PUCCH resources with a higher priority and a lower priority) with repetitions (e.g., slot based repetitions and/or subslot based repetitions) and configured with allowing deferral of the transmission of the HARQ-ACK information only for the SPS PDSCH reception(s) (e.g., deferral of the transmission of the HARQ-ACK information for any SPS PDSCH configuration, and the UE is configured with the 3GPP parameter spsHARQdeferral) at the same time. The method is simple to implement and can reduce the implementation complexity of the UE and the BS.

It may also be specified by protocols that approach MN44 is performed, if the UE is configured with a UCI multiplexing parameter allowing different priorities (e.g., 3GPP parameter UCI-MuxWithDifferentPriority), or approach MN44 is performed, if the UE is not configured with the UCI multiplexing parameter allowing different priorities (e.g., 3GPP parameter UCI-MuxWithDifferentPriority).

Approach MN9 (i.e., a ninth approach)

It may be specified by protocols and/or configured by higher layer signaling that the UE does not expect to be configured with allowing deferral of the transmission of the HARQ-ACK information only for the SPS PDSCH reception(s) (e.g., allow deferral of transmission of HARQ-ACK information for any SPS PDSCH configuration) when a number of repetitions in each of all PUCCH resources in the 3GPP parameter SPS-PUCCH-AN-List-r16 is different. The method is simple to implement and can reduce the implementation complexity of the UE and the BS.

A PUCCH transmission may be configured with repetitions. When the PUCCH transmission is configured with repetitions, how to determine the maximum deferral transmission time unit parameter K1′ is a problem to be addressed.

It may be specified by protocols and/or configured by higher layer signaling that, when a PUCCH transmission is configured with repetitions, the maximum deferral transmission time unit parameter K1′ is a maximum value of a time unit from the last/first repetition of the repetitions of the PUCCH transmission to the SPS PDSCH reception. The method clarifies the behavior of the UE, which can ensure the understanding consistency between the UE and the BS and improve the reliability of the uplink transmission.

It may be configured that only NACK is fed back for an SPS PDSCH reception (NACK only is configured for the SPS PDSCH reception), i.e., when the SPS PDSCH is successfully decoded, HARQ-ACK information is not transmitted, but when the SPS PDSCH is not successfully decoded, HARQ-ACK information (NACK) is transmitted. Alternatively, it may be configured that no HARQ-ACK is fed back for the SPS PDSCH reception, i.e., the UE does not transmit HARQ-ACK information for the SPS PDSCH reception. When the SPS PDSCH is activated, the UE may not transmit HARQ-ACK information for the first SPS PDSCH reception, and thus the BS cannot confirm whether the UE receives DCI activating the SPS PDSCH. In order to address this problem, at least one of the following approaches MN10 or MN11 may be adopted.

Approach MN10 (i.e., a tenth approach)

In approach MN10, a time unit interval parameter K 1a from a PUCCH with HARQ-ACK for a DCI format activating an SPS PDSCH to a PDCCH carrying the DCI format activating the SPS PDSCH may be configured by higher layer signaling. K1a may be a non-negative integer, and K1a may be separately and/or uniformly configured for different serving cells. The RRC signaling overhead and the UE implementation complexity may be reduced by uniformly configuring K1a for different serving cells. As a value of a minimum of K1a may be different when an SCS is different, if K1a is uniformly configured, a minimum value should be configured that satisfies all serving cells. The transmission delay of the HARQ-ACK under different SCSs may be reduced by separately configuring K1a for different serving cells. For example, when the UE receives a DCI format indicating activation of the SPS PDSCH, the UE determines a HARQ-ACK transmission time unit for the DCI format according to K1a. The UE determines a HARQ-ACK transmission time unit for the SPS PDSCH reception according to an indication of a K1 field in the DCI format. In this way, the HARQ-ACK feedback for the DCI format activating the SPS PDSCH can be ensured, and the reliability of the SPS PDSCH transmission can be improved.

Approach MN11 (i.e., an eleventh approach)

In approach MN11, a time unit interval parameter K1b from a PUCCH of HARQ-ACK for an SPS PDSCH reception to the SPS PDSCH reception may be configured by higher layer signaling. K1b may be a non-negative integer, and K1b may be separately and/or uniformly configured for different serving cells, or K1b may be separately and/or uniformly configured for different SPS PDSCH configurations. The RRC signaling overhead and the UE implementation complexity may be reduced by uniformly configuring K1b. This approach can improve the scheduling flexibility and reduce the transmission delay of the HARQ-ACK by separately configuring K1b. For example, when the UE receives a DCI format indicating activation of the SPS PDSCH, the UE determines a HARQ-ACK transmission time unit for the SPS PDSCH reception according to K1b. The UE determines a HARQ-ACK transmission time unit of the DCI format according to the indication of the K1 field in the DCI format. In this way, the HARQ-ACK feedback for the DCI format activating the SPS PDSCH can be ensured, and the reliability of the SPS PDSCH transmission can be improved.

The UE may be configured with a dynamic HARQ-ACK codebook and/or an enhanced dynamic HARQ-ACK codebook, and when an SPS PDSCH is activated, how to determine a DAI count is a problem to be addressed.

It may be specified by protocols and/or configured by higher layer signaling that, the DAI counts DCI formats activating SPS PDSCH. A corresponding position of HARQ-ACK information for a DCI format in the HARQ-ACK codebook is determined by a DAI indication in the DCI format. A HARQ-ACK bit for the first SPS PDSCH reception activated by the DCI format may be determined according to a determination method for HARQ-ACK bits for the non-first SPS PDSCH reception. For example, the HARQ-ACK bit for the first SPS PDSCH reception activated by the DCI format may be placed after HARQ-ACK bits corresponding to the DCI format (e.g., DCI format indicating activation of the SPS PDSCH and/or DCI format scheduling the PDSCH). In this way, the understanding of the HARQ-ACK codebook between the UE and the BS can be kept consistent, and the transmission reliability of the HARQ-ACK codebook can be improved.

The UE may be configured with a semi-static HARQ-ACK codebook, and when an SPS PDSCH is activated, how to determine a position of a HARQ-ACK bit for a DCI format activating the SPS PDSCH is a problem to be addressed.

In order to address this problem, at least one of the following approaches MN12 or MN13 may be adopted.

Approach MN12 (i.e., a twelfth approach)

In approach MN12, it may be specified by protocols and/or configured by higher layer signaling that the UE does not expect that HARQ-ACK for a DCI format activating the SPS PDSCH and HARQ-ACK for the first SPS PDSCH reception activated by the DCI format are transmitted in a same time unit. The method is simple to implement and can reduce the implementation complexity of the UE and the BS.

Approach MN13 (i.e., a thirteenth approach)

In approach MN13, it may be specified by protocols and/or configured by higher layer signaling that Nactivation bits are added/appended before or after an existing semi-static HARQ-ACK codebook to transmit HARQ-ACK information for a DCI format activating an SPS PDSCH. Nactivation may be a positive integer, and Nactivation may be configured by higher layer signaling and/or specified by protocols, e.g., Nactivation may be 1. If Nactivation is greater than 1, a HARQ-ACK bit for the DCI format activating the SPS PDSCH may be placed according to a time order (e.g., chronological order) of reception of the DCI format activating the SPS PDSCH. The method can simultaneously transmit the HARQ-ACK information for the DCI format activating the SPS PDSCH and the HARQ-ACK information for the first activated SPS PDSCH reception in a HARQ-ACK codebook, and can improve the reliability of the HARQ-ACK transmission.

When a PUCCH overlap with a PUSCH in time domain, UCI information carried in the PUCCH (e.g., UCI information other than SR; the UCI information may be HARQ-ACK, or CSI) may be multiplexed in the PUSCH, and then whether the PUSCH conflicts (e.g., overlaps in time domain) with semi-statically configured downlink symbols is determined. If the PUSCH conflicts with the semi-statically configured downlink symbols, the UE does not transmit the PUSCH. At this time, the UCI information carried in the PUSCH will be dropped or discarded. In this case, how to improve the reliability of the UCI transmission is a problem to be addressed.

For example, it may be specified by protocols and/or configured by higher layer signaling that, when a PUCCH overlaps with a PUSCH in time domain, if the PUSCH satisfies a predefined condition COND3 (herein, it may also be referred to as a third predefined condition or a third transmission condition), the UE may multiplex UCI carried in the PUCCH in the PUSCH, and the UE does not transmit the PUCCH. If the PUSCH does not satisfy the predefined condition COND3, the UE does not transmit the PUSCH, and the UE does not multiplex the UCI carried in the PUCCH in the PUSCH. For example, the predefined condition COND3 may be for determining that the PUSCH can be transmitted. For example, if a PUCCH with HARQ-ACK overlaps with a PUSCH in time domain, e.g., this PUSCH overlaps with semi-statically configured downlink symbols of a serving cell where the PUSCH is located, the UE does not multiplex the HARQ-ACK in the PUSCH. If the PUCCH with HARQ-ACK satisfies the predefined condition COND2 described previously, the UE transmits the PUCCH.

The predefined condition COND3 may be that the PUSCH of a serving cell does not overlap with a second predefined time unit (e.g., symbol) of this serving cell. For the convenience of description, the second predefined symbol is taken as an example for illustration. For example, the second predefined symbol may include at least one of:

a semi-statically configured downlink symbol (configured by higher layer signaling);

a downlink symbol indicated by a dynamic SFI;

a symbol of an SSB;

a symbol of CORESET0;

an unavailable symbol configured by higher layer signaling;

Y symbols after the SSB, where Y is an integer, which may be specified by protocols and/or configured by higher layer signaling;

a symbol indicated by an uplink cancellation indication (UL CI); or

a symbol where a PDSCH scheduled by a DCI format is located.

For example, the predefined condition COND3 may be that the PUSCH of a serving cell does not overlap with the semi-statically configured downlink symbol (configured by higher layer signaling), SSB, or CORESET0 of the serving cell in time domain.

The method can improve the reliability of the UCI transmission, reduce PDSCH retransmission and improve the spectrum efficiency of the system.

It may be specified by protocols and/or configured by higher layer signaling that, if at least one symbol in a PUSCH (e.g., a CG PUSCH) of a serving cell overlaps with the second predefined symbol of the serving cell in time domain, the UE does not generate a MAC PDU. If a PUSCH transmission is configured with repetitions, and at least one symbol in all of the repetitions (e.g., actual repetitions) overlaps with the second predefined symbol of this serving cell in time domain, the UE does not generate a MAC PDU.

A time when the UE determines whether to generate the MAC PDU may also be specified by protocols and/or configured by higher layer signaling. For example, whether to generate the MAC PDU is determined at N symbols before the starting symbol of a PUSCH. As another example, if a PUSCH transmission with repetitions is performed, whether to generate the MAC PDU is determined at N symbols before each of repetitions. At this time, if at least one symbol in each repetition transmission overlaps with the second predefined symbol of this serving cell in time domain, the MAC PDU is not generated. The method can ensure the understanding consistency between the UE and the BS on whether to generate the MAC PDU, and can avoid a scenario where the UE generates the MAC PDU but the BS considers that the UE does not generate the MAC PDU. In this scenario, data in the MAC PDU may be dropped or discarded in the physical layer and can only be transmitted through retransmission of the higher layer. The method can improve the reliability of the uplink data transmission and reduce the transmission delay of the uplink data.

The UE may be configured by higher layer signaling to support multiplexing of HARQ-ACK with the higher priority in a PUSCH with the lower priority. For example, a PUCCH with HARQ-ACK with the higher priority overlaps with a PUSCH with the lower priority in time domain, and the UE multiplexes the HARQ-ACK with the higher priority in the PUSCH with the lower priority. The UE may be configured by higher layer signaling to monitor a UL CI (e.g., DCI format 2_4 scrambled by CI-RNTI), and if a symbol indicated by the UL CI (e.g., a symbol of a serving cell where the PUSCH is located) overlaps with the PUSCH with the lower priority, the UE may cancel transmission of the PUSCH with the lower priority. At this time, the HARQ-ACK with the higher priority will also be cancelled.

In order to improve the transmission reliability of the HARQ-ACK with the higher priority, it may be specified by protocols and/or configured by higher layer signaling that the UE does not expect that a PUSCH (e.g., the PUSCH may be a PUSCH with the higher priority and/or a PUSCH with the lower priority) with HARQ-ACK (e.g., the HARQ-ACK may be HARQ-ACK with the higher priority and/or HARQ-ACK with the lower priority) on a serving cell overlaps with a symbol indicated by a UL CI for the serving cell. Alternatively, the UE does not expect that a PUSCH (e.g., the PUSCH may be a PUSCH with the lower priority) with HARQ-ACK (e.g., the HARQ-ACK may be HARQ-ACK with the higher priority and/or HARQ-ACK with the lower priority) is cancelled by a UL CI. Alternatively, an indication of a UL CI (DCI format 2_4) for a serving cell is applicable to transmission of a PUSCH (e.g., the PUSCH may be a PUSCH with the higher priority and/or a PUSCH with the lower priority) that does not contain HARQ-ACK (e.g., the HARQ-ACK may be HARQ-ACK with the higher priority and/or HARQ-ACK with the lower priority) on the serving cell. The method can improve the reliability of the UCI transmission, reduce PDSCH retransmission and improve the spectrum efficiency of the system.

When the UE is configured with different priorities (e.g., physical layer priorities), how to multiplex and/or prioritize PUCCHs and/or PUSCHs with different priorities is a problem to be addressed. It may be addressed according to step S11 and/or step S12.

Step S11: PUCCHs and/or PUSCHs with the same priority that overlap in time domain are multiplexed and/or prioritized, e.g., according to any suitable method (e.g., the methods defined in 3GPP).

Step S12: PUCCHs and/or PUSCHs with different priorities that overlap in time domain are multiplexed and/or prioritized.

In step S12 (e.g., after the end of step S11), if there are multiple PUCCHs overlapping in time domain, the multiple PUCCHs may first be multiplexed and/or prioritized, to obtain one PUCCH or multiple PUCCHs that do not overlap in time domain.

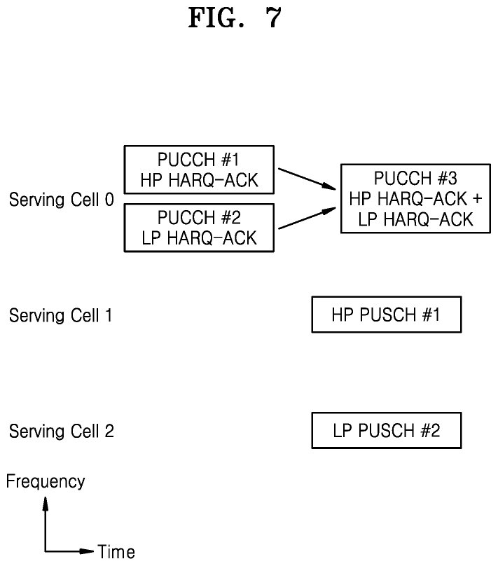

FIG. 7 illustrates a PUCCH overlapping with a PUSCH in time domain according to an embodiment.

Referring to FIG. 7, PUCCH #1 on serving cell 0 (primary serving cell) includes a high priority (HP) HARQ-ACK, PUCCH #2 includes low priority (LP) HARQ-ACK, and HP PUSCH #1 on serving cell 1 does not overlap with PUCCH #1 in time domain. LP PUSCH #2 on serving cell 2 does not overlap with PUCCH #2 in time domain. The PUCCHs and/or PUSCHs with the same priority do not overlap in time domain, and step one is not performed. When UCI in PUCCH #1 and UCI in PUCCH #2 are multiplexed in PUCCH #3 at step S12, how to multiplex UCI in PUCCH #3 in the PUSCH is a problem to be addressed.

In some implementations, it may be specified by protocols and/or configured by higher layer signaling. If a PUCCH includes HARQ-ACK with the lower priority and HARQ-ACK with the higher priority (or if a PUCCH includes the HARQ-ACK with the higher priority), and the PUCCH overlaps with both a PUSCH with the higher priority and a PUSCH with the lower priority, at least one of the following approaches may be adopted.

Approach MN14 (i.e., a fourteenth approach): the HARQ-ACK with the lower priority and the HARQ-ACK with the higher priority are multiplexed in the PUSCH with the higher priority. This can improve the reliability of the HARQ-ACK transmission.

Approach MN15 (i.e., a fifteenth approach): the HARQ-ACK with the lower priority and the HARQ-ACK with the higher priority are multiplexed in the PUSCH with the lower priority. This can improve the transmission reliability of the PUSCH with the higher priority.

Approach MN16 (i.e., a sixteenth approach): the UE does not expect that the PUCCH with the HARQ-ACK with the higher priority and the HARQ-ACK with the lower priority overlaps with the PUSCH with the lower priority and the PUSCH with the higher priority in time domain at the same time. The method is simple to implement and can reduce the implementation complexity of the UE and the BS.

Approach MN17 (i.e., a seventeenth approach): the UE selects the PUSCH according to a predefined order of priority (e.g., in an order from a higher priority to a lower priority). For example, the predefined order of priority, from high to low, may be: {HP DG (Dynamic grant) PUSCH (a PUSCH scheduled by a DCI format), LP DG PUSCH, HP CG PUSCH, LP CG PUSCH}. The method can determine the HARQ-ACK codebook by the UL DAI, which can improve the reliability of the uplink transmission and avoid the influence of missing detection for the DCI on the reliability of the CG PUSCH.

Approach MN41 (i.e., a forty-first approach): the UE does not expect that the PUCCH with the HARQ-ACK with the higher priority and the HARQ-ACK with the lower priority overlaps with a PUSCH with the lower priority or a PUSCH with the higher priority in time domain. The method is simple to implement and can reduce the implementation complexity of the UE and the BS.

The method of multiplexing and/or prioritization of the PUCCH with the HARQ-ACK with the higher priority and the HARQ-ACK with the lower priority and other uplink channels in accordance with an embodiment of the disclosure is also applicable to multiplexing and/or prioritization of a PUCCH with HARQ-ACK with the higher priority, SR with the higher priority and HARQ-ACK with the lower priority, and other uplink channels. For example, the “PUCCH with the HARQ-ACK with the higher priority and the HARQ-ACK with the lower priority” may be replaced with the “PUCCH with the HARQ-ACK with the higher priority, the SR with the higher priority and the HARQ-ACK with the lower priority”, or the “PUCCH including the HARQ-ACK of the higher priority and the HARQ-ACK of the lower priority”, or the “PUCCH after multiplexing and/or prioritization of the PUCCH with the HARQ-ACK with the higher priority and the PUCCH with the HARQ-ACK with the lower priority”, or the “PUCCH after multiplexing and/or prioritization of the PUCCH including the HARQ-ACK of the higher priority and the PUCCH including the HARQ-ACK of the lower priority”.

If a PUCCH with the lower priority overlaps with a PUCCH with the higher priority in time domain, a conflict between the PUCCH with the higher priority and a PUCCH with HARQ-ACK with the lower priority can be resolved first, and then a conflict between the PUCCH with the higher priority and a PUCCH without the HARQ-ACK with the lower priority (e.g., the PUCCH with the SR and/or CSI with the lower priority) can be resolved. After the HARQ-ACK with the lower priority is multiplexed with the HARQ-ACK with the higher priority, it may be transmitted in a new PUCCH resource with the higher priority.

If the PUCCH with the SR and/or CSI with the lower priority does not overlap with the new PUCCH with the higher priority in time domain, the PUCCH with the SR and/or CSI with the lower priority may be transmitted, which can improve the probability of transmission of the PUCCH with SR and/or CSI with the lower priority. For example, the PUCCH in the method may be a PUCCH of which a transmission is not configured with repetitions. Alternatively, it may be specified by protocols that the UE does not expect that the PUCCH with the HARQ-ACK with the higher priority and the HARQ-ACK with the lower priority overlaps with the PUCCH with the lower priority (e.g., the PUCCH with the SR and/or CSI with the lower priority) in time domain. The method is simple to implement and can reduce the implementation complexity of the UE and the BS.

The PUCCH and/or PUSCH that may be multiplexed may satisfy a predefined multiplexing condition, e.g., satisfying a timing relationship (timing condition) for multiplexing. Herein, the timing relationship and the timing condition may be used interchangeably.

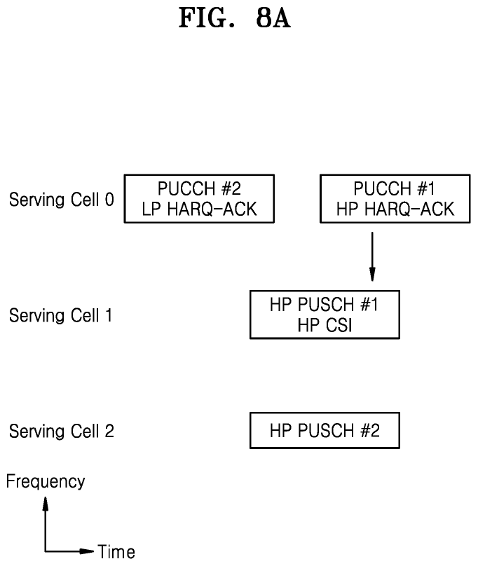

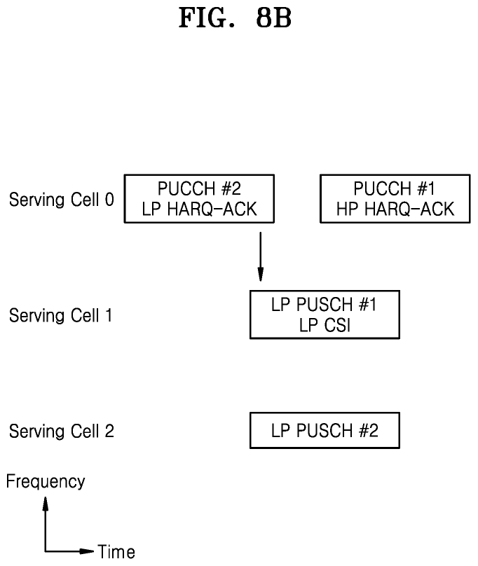

FIGS. 8A and 8B illustrate a PUCCH overlapping with a PUSCH in time domain according to an embodiment.

Referring to FIG. 8A, PUCCH #1 on serving cell 0 (primary serving cell) includes an HP HARQ-ACK, PUCCH #2 includes an LP HARQ-ACK, an HP PUSCH #1 on serving cell 1 includes CSI (e.g., aperiodic CSI), and an HP PUSCH #1 overlaps with both PUCCH #1 and PUCCH #2 in time domain. HP PUSCH #2 on serving cell 2 overlaps with both PUCCH #1 and PUCCH #2 in time domain.

Referring to FIG. FIG. 8B, PUCCH #1 on serving cell 0 (primary serving cell) includes an HP HARQ-ACK, PUCCH #2 includes an LP HARQ-ACK, LP PUSCH #1 on serving cell 1 includes CSI (e.g., aperiodic CSI), and LP PUSCH #1 overlaps with both PUCCH #1 and PUCCH #2 in time domain. LP PUSCH #2 on serving cell 2 overlaps with both PUCCH #1 and PUCCH #2 in time domain.

In step S11, for FIG. 8A, HP HARQ-ACK is multiplexed in HP PUSCH #1, and for FIG. 8B, LP HARQ-ACK is multiplexed in LP PUSCH #1.

In step S12, how to multiplex UCI included in PUCCH #2 in the PUSCH is a problem to be addressed.

It may be specified by protocols and/or configured by higher layer signaling that, if a PUCCH overlaps with multiple PUSCHs in time domain, where a priority of the multiple PUSCHs is different from that of the PUCCH, the following approaches may be adopted. For example, the overlapping of the PUCCH with the multiple PUSCHs in time domain may indicate that the PUCCH includes HARQ-ACK with a priority, and the PUCCH overlaps with multiple PUSCHs with another priority in time domain. In some examples, the priority may be greater than the other priority, and in this case, the priority is the higher priority and the other priority is the lower priority. In other examples, the priority may be lower than the other priority, and in this case, the priority may be the lower priority and the other priority may be the higher priority.

Approach MN18 (i.e., an eighteenth approach): the UE selects the PUSCH according to a predefined order of priority. For example, the predefined order of priority may include at least one of:

{PUSCH without UCI, PUSCH with UCI} (in an order of priority from high to low). If there are many types of UCI on a PUSCH, the UE may drop or discard a part of the UCI, and the method can avoid discarding the UCI.

{DG PUSCH without UCI, DG PUSCH with UCI, CG PUSCH without UCI, CG PUSCH with UCI} (in an order of priority from high to low). Compared with a CG PUSCH, a DG PUSCH can improve the reliability of the UCI transmission. The method makes a compromise with discarding the UCI and improving the reliability of the UCI transmission. To ensure the reliability of the UCI transmission, discarding of the UCI may be avoided as much as possible.

{PUSCH without CSI, PUSCH with CSI} (in an order of priority from high to low). If there are many types of UCI on a PUSCH, the UE may drop or discard a part of the UCI, and the method can avoid discarding the UCI.

{PUSCH with CSI, PUSCH without CSI} (in an order of priority from high to low).

{DG PUSCH without CSI, PUSCH with CSI (e.g., DG PUSCH), CG PUSCH (e.g., CG PUSCH without CSI)} (in an order of priority from high to low). If there are many types of UCI on a PUSCH, the UE may drop or discard a part of the UCI, and the method can avoid discarding the UCI.

{HP PUSCH without HP HARQ-ACK, HP PUSCH with HP HARQ-ACK} (in an order of priority from high to low). If there are many types of UCI on a PUSCH, UE may drop or discard a part of the UCI, and the method can avoid discarding the UCI. A missed detection may occur for an LP HARQ-ACK, and the method can improve the reliability of an HP HARQ-ACK.

{HP PUSCH with HP HARQ-ACK, HP PUSCH without HP HARQ-ACK} (in an order of priority from high to low).

{DG PUSCH indicated by DCI to be able to be multiplexed with a PUCCH, a PUSCH configured by higher layer signaling to be able to be multiplexed with PUCCH (e.g., a CG PUSCH, or a PUSCH scheduled by DCI format 0_0), a DG PUSCH not indicated by DCI to be able to be multiplexed with PUCCH} (in an order of priority from high to low).

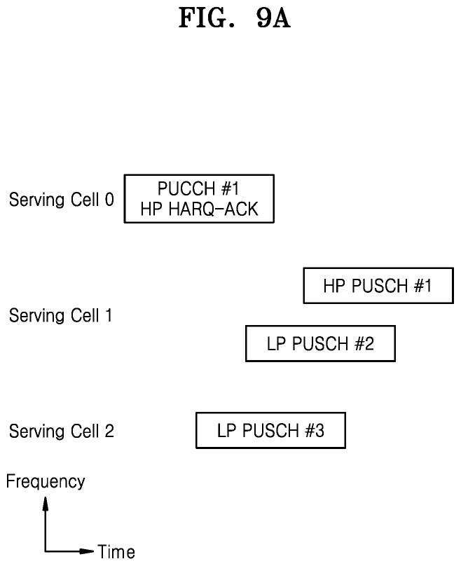

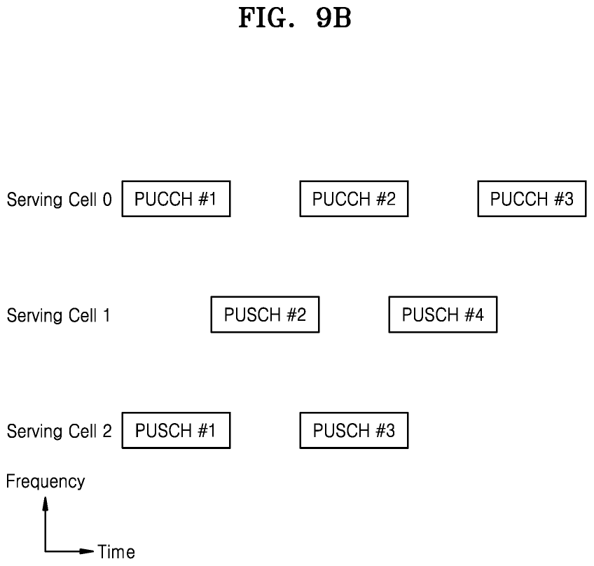

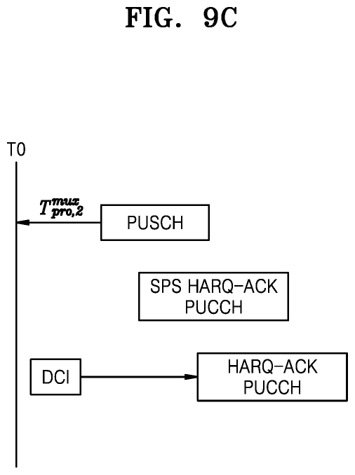

FIG. 9A illustrates a PUCCH overlapping with a PUSCH in time domain according to an embodiment.

Referring to FIG. 9A, PUCCH #1 on serving cell 0 (primary serving cell) includes an HP HARQ-ACK, and HP PUSCH #1 on serving cell 1 does not overlap with PUCCH #1 in time domain. LP PUSCH #2 on service cell 1 overlaps with PUCCH #1 in time domain. LP PUSCH #3 on serving cell 2 overlaps with PUCCH #1 in time domain. PUCCH #1 and/or PUSCH #1 with the same priority do not overlap in time domain, and step S11 is not performed.

In step S12, how to multiplex UCI in PUCCH #1 in the PUSCH is a problem to be addressed.

It may be specified by protocols and/or configured by higher layer signaling that, if a PUCCH overlaps with multiple PUSCHs in time domain, where a priority of the multiple PUSCHs is different from that of the PUCCH, at least one of the following approaches MN19 or MN20 may be adopted.

Approach MN19 (i.e., a nineteenth approach): the PUCCH and/or PUSCHs may be multiplexed and/or prioritized according to one or more of the following steps S121, S122 and S123.

S121: for each serving cell, if a PUSCH with the lower priority of the serving cell overlaps with a PUSCH with the higher priority of the serving cell in time domain, the UE does not transmit (cancels transmission of) the PUSCH with the lower priority.

S122: if more than one PUCCH overlaps in time domain, the more than one PUCCH is multiplexed and/or prioritized, e.g., according to any suitable method (e.g., predefined rules). For example, the predefined rules may be rules defined in other examples of the disclosure and/or rules defined in 3GPP.

S123: PUCCHs and/or PUSCHs are multiplexed and/or prioritized, e.g., according to any suitable method (e.g., predefined rules). For example, the predefined rules may be rules defined in other examples of the disclosure and/or rules defined in 3GPP.

Steps S121, S122 and S123 in approach MN19 may be performed in any order, or the steps S121, S122 and S123 may be performed simultaneously.

In step S123 in approach MN19, the PUCCHs and/or PUSCHs may be multiplexed and/or prioritized according to the following sub-steps.

Sub-step 1: the PUCCH with the lower priority and/or the PUSCH (e.g., the PUSCH with the lower priority and/or the higher priority) is multiplexed and/or prioritized, e.g., according to any suitable method (e.g., predefined rules). For example, the predefined rules may be rules defined in other examples of the disclosure and/or rules defined in 3GPP.

Sub-step 2: the PUCCH with the higher priority and/or the PUSCH (e.g., the PUSCH with the lower priority and/or the higher priority) is multiplexed and/or prioritized, e.g., according to any suitable method (e.g., predefined rules). For example, the predefined rules may be rules defined in other examples of the disclosure and/or rules defined in 3GPP.

The order of sub-step 1 and sub-step 2 may be exchanged, or the sub-step 1 and sub-step 2 may be performed simultaneously (e.g., regardless of the priority of the PUCCH).

The method can prevent the UCI from being cancelled after being multiplexed in the PUSCH, and can improve the reliability of the UCI transmission.

Approach MN20 (i.e., a twentieth approach): the UE does not expect that a PUCCH with HARQ-ACK (e.g., HARQ-ACK with the higher priority) is multiplexed in a PUSCH with the lower priority on a serving cell, where the PUSCH with the lower priority overlaps with another PUSCH with the higher priority on the serving cell in time domain. The method is simple to implement and can reduce the implementation complexity of the UE and the BS.

Multiplexing and/or prioritization of multiple PUCCHs and/or PUCCHs that overlap in time domain should satisfy a predefined timing condition. The predefined timing condition may be determined according to a UE capability report and/or specification of protocols.

The timing condition to be satisfied by the multiplexing and prioritization may be the same, e.g., the timing conditions specified in 3GPP TS38.213 Release 15. All PUCCHs and/or PUSCHs that overlap in time domain may satisfy the timing condition.

The timing condition to be satisfied by the multiplexing and prioritization may also be the same, e.g., the timing condition for the multiplexing may be the timing conditions specified in 3GPP TS38.213 Release 15, and all PUCCHs and/or PUSCHs overlapping in time domain that may be multiplexed should satisfy the timing condition for the multiplexing. The timing condition for the prioritization may be the timing conditions specified in 3GPP TS38.213 Release 16, and all PUCCHs and/or PUSCHs overlapping in time domain that may not be multiplexed (may be prioritized) should satisfy the timing condition for the prioritization.

Whether a PUCCH and/or a PUSCH with different priorities can be multiplexed may be dynamically indicated by DCI. For example, whether the PUSCH can be multiplexed with the PUCCH (e.g., HARQ-ACK) with a different priority may be indicated in DCI scheduling the PUSCH. For example, when a PUCCH with the lower priority overlaps with two or more PUSCHs with the higher priority in time domain at the same time, the DCI may indicate multiplexing of the PUCCH with the lower priority in one of the PUSCHs, where the PUSCH and the PUCCH should satisfy the predefined timing condition. It may be specified by protocols and/or determined by a capability reported by the UE that a PUSCH that is not multiplexed with the PUCCH (e.g., HARQ-ACK) with the lower priority and the PUCCH do not need to satisfy the predefined timing condition.

The PUSCH may be scheduled by the DCI (e.g., a DG PUSCH) and/or a PUSCH not scheduled by the DCI (e.g., a CG PUSCH).

If a PUCCH (e.g., HARQ-ACK with the lower/higher priority) overlaps with multiple PUSCHs (e.g., PUSCHs with the higher/lower priority) in time domain, and/or the UE is configured by higher layer signaling that whether the PUCCH and/or PUSCHs with different priorities may be multiplexed may be indicated by the DCI, it may be specified by protocols and/or configured by higher layer signaling that at least one of the following approaches MN21˜MN24 is adopted.

Approach MN21 (i.e., a twenty-first approach): the UE does not expect to be indicated by DCI to multiplex a PUCCH in more than one PUSCH, and/or the UE does not expect to not be indicated by DCI to multiplex a PUCCH in any PUSCH. The method is simple to implement, can reuse the existing implementation approaches, and can reduce the implementation complexity of the UE and the BS.

Approach MN22 (i.e., a twenty-second approach): if the UE is indicated by DCI to multiplex a PUCCH in more than one PUSCH, the UE multiplexes UCI included in the PUCCH in the more than one PUSCH. The method can improve the reliability of the UCI transmission.

Approach MN23 (i.e., a twenty-third approach): if the UE is indicated by DCI to multiplex a PUCCH in more than one PUSCH, and/or if the UE is not indicated by DCI to multiplex a PUCCH in any PUSCH, the UE multiplexes UCI included in the PUCCH in a PUSCH. The UE may determine the PUSCH according to a predefined method, e.g., according to the methods specified in 3GPP TS 38.213. The method is simple to implement, can multiplex the existing implementation approaches, and can reduce the implementation complexity of the UE and the BS.

Approach MN24 (i.e., a twenty-fourth approach): if the UE is not indicated by DCI to multiplex a PUCCH in any PUSCH, the UE transmits the PUCCH and/or the PUSCH with the higher priority, and the UE does not transmit the PUCCH and/or the PUSCH with the lower priority. This scenario may be a missed detection for the DCI transmission. The method clarifies the behavior of the UE, which can ensure the understanding consistency between the UE and the BS when a missed detection occurs for the DCI, and improve the reliability of the uplink transmission.

If the UE is configured by higher layer signaling to indicate whether PUCCHs and/or PUSCHs with different priorities may be multiplexed by the DCI, all of the PUCCHs and/or PUSCHs that overlap in time domain need to satisfy a predefined timing condition. For example, the timing condition may be the timing conditions specified in 3GPP TS38.213 Release 15.

Since whether a PUCCH (UCI) and/or a PUSCH may be multiplexed cannot be dynamically indicated in fallback DCI (e.g., DCI format 0_0, or DCI format 1_0), it may be specified by protocols and/or configured by higher layer signaling whether a PUSCH scheduled by a DCI format 00 may be multiplexed with UCI (e.g., HARQ-ACK) with the higher priority or a PUCCH with the UCI. It may be specified by protocols and/or configured by higher layer signaling whether a PUCCH with HARQ-ACK that is scheduled by a DCI format 10 may be multiplexed with a PUCCH and/or a PUSCH with the higher priority. When UCI is carried/included by/in a PUCCH, the UCI and the PUCCH may be used interchangeably.

Since a CG PUSCH is not scheduled by DCI, and whether a PUCCH and/or the CG PUSCH may be multiplexed cannot be dynamically indicated, it may be specified by protocols and/or configured by higher layer signaling and/or dynamically indicated by DCI (e.g., DCI activating CG PUSCH) whether the CG PUSCH may be multiplexed with UCI (e.g., HARQ-ACK) with a different priority.

If a PUSCH (e.g., a PUSCH of a serving cell) is configured by higher layer signaling that it may be transmitted simultaneously with a PUCCH (e.g., the PUCCH may be a PUCCH with the same priority as the PUSCH and/or a PUCCH with a different priority than the PUSCH), the PUSCH does not need to satisfy a timing condition for multiplexing and/or prioritization. For example, when a PUSCH supporting simultaneous transmission (e.g., simultaneous transmission of a PUCCH and the PUSCH) overlaps with the PUCCH and/or other PUSCHs in time domain, the PUSCH supporting simultaneous transmission does not need to satisfy the timing condition for multiplexing and/or prioritization with the PUCCH and/or other PUSCHs. The method can improve the scheduling flexibility, and reduce the delay of the uplink transmission.

If a first PUSCH on a serving cell is configured by higher layer signaling and/or indicated by dynamic signaling that it may be transmitted simultaneously with a PUCCH (e.g., the PUCCH may be a PUCCH with a different priority than the PUSCH and/or a PUCCH with a different priority than the PUSCH), the first PUCCH does not need to satisfy the timing condition for multiplexing and/or prioritization with the PUCCH. If the first PUSCH overlaps with a second PUSCH on the serving cell (e.g., a priority of the first PUSCH is different from that of the second PUSCH) in time domain, the first PUSCH and the second PUSCH should satisfy a predefined timing condition. For example, the predefined timing conditions may be a timing condition for prioritization. For another example, the predefined timing condition may be a timing condition for multiplexing.

A first PUSCH with the higher priority scheduled by a PDCCH (e.g., a PDCCH carrying a DCI format) may overlap with a second PUSCH with the lower priority in time domain, and the UE expects that the transmission of the first PUSCH would not start before T_{proc,2} after a last symbol of the corresponding PDCCH reception, where T_{proc,2} is preparation time of the PUSCH (e.g., the first PUSCH) determined according to a UE capability (e.g., corresponding to a UE processing capability), such as the UE processing time defined in 3GPP TS 38.213.

A first PUSCH with the higher priority scheduled by a PDCCH (e.g., a PDCCH carrying a DCI format) may overlap with a second PUSCH with the lower priority in time domain, and the earliest starting time S₀ in the transmission of the first PUSCH and the transmission of the second PUSCH transmission is not before a symbol with CP starting after T_{proc,2}^{mux} after a last symbol of a PDCCH reception (e.g., the PDCCH may be a PDCCH carrying a DCI format scheduling the first PUSCH and/or the second PUSCH), where T_{proc,2}^{mux} is a maximum value of {T_{proc,2}^{mux,1}, T_{proc,2}^{mux,2}}, and T_{proc,2}^{mux,1} and T_{proc,2}^{mux,2} are preparation time of the PUSCH determined according to the UE capability (for example, corresponding to the UE processing capability), respectively, such as the UE processing time defined in 3GPP TS 38.213.

A reference point of the timing condition may be determined by at least one of the following approaches MN45˜MN49.

Approach MN45 (i.e., a forty-fifth approach)

In approach MN45, the starting symbol (or position) (or end symbol (or position)) of a slot (or subslot) (e.g., a slot (or subslot) with the higher (or lower) priority).

The method is simple to implement and can reduce the implementation complexity of the UE and the BS.

Approach MN46 (i.e., a forty-sixth approach)

In approach MN46, the starting symbol (or position) of a PUCCH with the earliest starting symbol of PUCCH resource(s) in a slot (or subslot) (e.g., a slot (or subslot) with the higher (or lower) priority). For example, the PUCCH resource(s) may be available PUCCH resources (e.g., a PUCCH resource that does not overlap with downlink symbols configured by higher layer signaling).

The method is simple to implement and can reduce the implementation complexity of the UE and the BS. Compared with MN45, MN46 can improve the scheduling flexibility and reduce the delay.

Approach MN47 (i.e., a forty-seventh approach)

In approach MN47, the starting symbol (or position) of a PUCCH with the earliest starting symbol from among PUCCH(s) with only HARQ-ACK and/or PUCCH(s) with only an SR in a slot (or subslot) (e.g., a slot (or subslot) with the higher (or lower) priority).

The method is simple to implement and can reduce the implementation complexity of the UE and the BS.

Approach MN48 (i.e., a forty-eighth approach)

In approach MN48, the starting symbol (or position) of a PUCCH with the earliest starting symbol from among PUCCH(s) with only HARQ-ACK and/or PUCCH(s) with only SR that overlap with an uplink channel with the lower priority in time domain.

The method is simple to implement and can reduce the implementation complexity of the UE and the BS.

Approach MN49 (i.e., a forty-ninth approach)

In approach MN49, the starting symbol (or position) of a PUSCH with the earliest starting symbol from among PUSCH(s). The PUSCH(s) may be a PUSCH overlapping with an uplink channel with the lower priority.

The method is simple to implement and can reduce the implementation complexity of the UE and the BS.

The reference point of the determined timing condition may be an earlier reference point in time order from among the reference points determined in approaches MN47 and/or MN48 and/or MN49.

The slot may be a slot of a PUCCH and/or a slot of a PUSCH.

A PDCCH scheduling a PUCCH and/or a PUSCH is earlier than a predefined time of the reference point of the determined timing condition (e.g., the predefined time may be Tproc,2+d1), where d1 is a parameter with respect to the processing time capability of the UE reported by the UE through the UE capability. For example, if the UE is not configured with a UCI multiplexing parameter enabling different priorities (e.g., 3GPP parameter UCI-MuxWithDifferentPriority), the PDCCH with the higher priority that schedules the PUCCH and/or the PUSCH is earlier than the predefined time of the reference point of the determined timing condition. Optionally, if a PUCCH and/or a PUSCH with the lower priority overlaps with a multiplexed PUCCH and/or PUSCH with the higher priority in time domain, the UE cancels transmission of the PUCCH and/or the PUSCH with the lower priority. For example, the transmission may be cancelled from an overlapping symbol.

The method clarifies the timing condition that a PUSCH supporting simultaneous transmission of a PUCCH and the PUSCH should satisfy, which can improve the scheduling flexibility and reduce the delay of the uplink scheduling.

The timing condition that a PUSCH supporting simultaneous transmission of a PUCCH and the PUSCH satisfies may also be applicable to a PUSCH scheduled by the DCI format, in which the PUSCH is indicated not to be multiplexed with a PUCCH/UCI (e.g., PUCCH/UCI with a different priority than the PUSCH). Therein, the UCI may be HARQ-ACK.

The PUSCH may be a PUSCH that does not support simultaneous transmission of a PUCCH and the PUSCH.

When PUCCH(s) and/or PUSCH(s) with different priorities can be multiplexed may be dynamically indicated by DCI. If the UE detects a DCI scheduling a PUSCH, which indicates that the PUSCH and UCI are multiplexed, and there is no PUCCH (e.g., the UE does not detect a PUCCH indicated by the DCI) that overlaps with the PUSCH in time domain, it may be specified by protocols and/or configured by higher layer signaling that at least one of the following approaches MN25˜MN26 is adopted.

Approach MN25 (i.e., a twenty-fifth approach): the UE does not expect that it is indicated by DCI to multiplex a PUCCH in a PUSCH, and there is no PUCCH (e.g., the UE does not detect a PUCCH indicated by the DCI) that overlaps with the PUSCH in time domain. The method is simple to implement, can reuse the existing implementation approaches, and can reduce the implementation complexity of the UE and the BS.

Approach MN26 (i.e., a twenty-sixth approach): the UE multiplexes HARQ-ACK in the PUSCH, and the UE generates a HARQ-ACK codebook according to a DAI indication. For a semi-static HARQ-ACK codebook, if the DAI indicates 1, the UE generates the semi-static HARQ-ACK codebook according to a predefined method. For example, the UE generates the semi-static HARQ-ACK codebook according to the method specified in TS 38.213 9.1.2.1. If the DAI indicates 0, the UE generates 1-bit NACK.

For a dynamic HARQ-ACK codebook, the UE generates the HARQ-ACK codebook according to the DAI indication. For example, when the DCI corresponds to HARQ-ACK bits of N-bits, and the DAI indicates M, a number of HARQ-ACK bits is M×N. The method can improve the reliability of the uplink data transmission.

For the semi-static HARQ-ACK codebook and/or the dynamic HARQ-ACK codebook, approach MN26 may be used in a scenario where a slot length of the PUSCH is not greater than a time unit length of the PUCCH. A PUSCH will only overlap with a PUCCH with HARQ-ACK in time domain.

It may be specified by protocols and/or configured by higher layer signaling and/or indicated by dynamic signaling (e.g., the dynamic signaling may be the PDCCH and/or DCI) that a PUCCH with HARQ-ACK for SPS PDSCH reception(s) with the higher priority may be multiplexed with a PUCCH with HARQ-ACK with the lower priority. If the UE is not configured (e.g., not configured in a PUCCH configuration with the higher priority) with multiple PUCCH resources with the higher priority (e.g., 3GPP parameter SPS-PUCCH-AN-List) that carry HARQ-ACK for SPS PDSCH(s) and/or the UE is only configured (e.g., in an SPS PDSCH configuration with the higher priority) with a PUCCH resource (e.g., 3GPP parameter n1PUCCH-AN) carrying HARQ-ACK for SPS PDSCH(s), when a PUCCH with HARQ-ACK for SPS PDSCH reception(s) with the higher priority overlaps with a PUCCH with HARQ-ACK with the lower priority in time domain, it may be specified by protocols and/or configured by higher layer signaling and/or indicated by dynamic signaling that at least one of the following approaches MN27˜MN31 is adopted.

Approach MN27 (i.e., a twenty-seventh approach): the UE does not expect to be indicated by DCI to multiplex HARQ-ACK with the lower priority in a PUCCH with HARQ-ACK for SPS PDSCH reception(s) with the higher priority, and a sum of numbers of HARQ-ACK bits with different priorities is greater than a predetermined number (e.g., 2). The method is simple to implement, can reuse the existing implementation approaches, and can reduce the implementation complexity of the UE and the BS.

Approach MN28 (i.e., a twenty-eighth approach): if a sum of a number of HARQ-ACK bits with the lower priority and a number of HARQ-ACK bits with the higher priority is greater than a predetermined number (e.g., 2), the UE transmits the PUCCH with the HARQ-ACK with the higher priority, and the UE does not transmit the PUCCH with the HARQ-ACK with the lower priority. The method can improve the reliability of transmission of the HARQ-ACK with the higher priority. Compared with other methods, the method can improve the scheduling flexibility.

Approach MN29 (i.e., a twenty-ninth approach): the UE does not expect that a PUCCH with HARQ-ACK for SPS PDSCH reception(s) with the higher priority overlaps with a PUCCH with HARQ-ACK with the lower priority in time domain, and a sum of numbers of HARQ-ACK bits with different priorities is greater than a predetermined number (e.g., 2). The method is simple to implement, can reuse the existing implementation approaches, and can reduce the implementation complexity of the UE and the BS.

Approach MN30 (i.e., a thirtieth approach): the UE does not expect that a PUCCH with HARQ-ACK for SPS PDSCH reception(s) with the higher priority overlaps with a PUCCH with the HARQ-ACK with the lower priority that is indicated by the DCI in time domain, and a sum of numbers of bits of HARQ-ACK with different priorities is greater than a predetermined number (e.g., 2). The method is simple to implement, can reuse the existing implementation approaches, and can reduce the implementation complexity of the UE and the BS. Compared with the twenty-ninth approach, the thirtieth approach can improve the scheduling flexibility.

Approach MN31 (i.e., a thirty-first approach): the UE transmits a PUCCH with HARQ-ACK only for SPS PDSCH receptions with the higher priority, and the UE does not transmit a PUCCH with HARQ-ACK with the lower priority. The method can reduce the implementation complexity of the UE and the BS, and ensure the reliability of transmission of the HARQ-ACK with the higher priority.

It may also be specified by protocols that the UE does not expect that the UE is configured to be able to multiplex a PUCCH with HARQ-ACK with the higher priority (e.g., HARQ-ACK for SPS PDSCH reception(s)) with a PUCCH with HARQ-ACK with the lower priority, and that the UE is not configured (e.g., not configured in the PUCCH configuration with the higher priority) with multiple PUCCH resources with the higher priority (e.g., 3GPP parameter SPS-PUCCH-AN-List) that carry the HARQ-ACK for the SPS PDSCH at the same time.

In addition, one or more steps or one or more operations in the methods described in embodiments of the disclosure may be specified by protocols and/or configured by higher layer signaling and/or indicated by dynamic signaling. The dynamic signaling may be a PDCCH and/or DCI. For example, an SPS PDSCH and/or CG PUSCH may be dynamically indicated in an active DCI/PDCCH thereof.

A PUSCH scheduled by a DCI format may be indicated in the DCI format whether it may be multiplexed with a PUCCH/UCI (e.g., PUCCH/UCI with a different priority than the PUSCH). If no multiplexing is indicated in the DCI format, the PUSCH and the PUCCH is required to satisfy the timing conditions for multiplexing specified in 3GPP TS38.213 Release 15 and/or the timing conditions for prioritization specified in 3GPP TS38.213 Release 16. Which timing condition is to be satisfied may depend on a UE capability and/or a higher layer signaling configuration. The timing conditions for multiplexing specified in 3GPP TS38.213 Release 15 are simple to implement, which can avoid undefined UE behaviors when the UE does not detect the DCI format indicating multiplexing, and improve the reliability of the uplink transmission. The timing conditions for prioritization specified in 3GPP TS38.213 Release 16 can improve the scheduling flexibility and reduce the delay of the uplink transmission.

In some implementations, the PUSCH scheduled by the DCI format may be indicated in the DCI format whether it may be multiplexed with the PUCCH/UCI (e.g., PUCCH/UCI with a different priority than the PUSCH), where the UCI may be HARQ-ACK. If no multiplexing is indicated in the DCI format, the PUSCH and the PUCCH is not required to satisfy the timing condition for multiplexing and/or prioritization. The method can further improve the scheduling flexibility and reduce the delay of the uplink transmission. If there are more than two PUSCHs and/or PUCCHs overlapping in time domain, “the PUSCH and the PUCCH” as described herein may be replaced with “the set of PUSCHs/PUCCHs”, where “the set of PUSCHs/PUCCHs” refers to a set of PUCCHs/PUSCHs that overlap in time domain. For example, a set of PUSCHs/PUCCHs may be PUCCHs and PUSCHs overlapping with the PUCCHs in time domain.

The UE is configured to multiplex HARQ-ACK with different priorities in a PUCCH and/or a PUSCH. For example, the UE may be configured with 3GPP parameters pucch-HARQ-ACK-MuxWithDiferentPriority and/or pusch-HARQ-ACK-MuxWithDifferentPriority. The UE may first multiplex and/or prioritize PUCCHs and/or PUSCHs with the same priority, and then multiplex and/or prioritize PUCCHs and/or PUSCHs with different priorities. When multiplexing the PUCCHs and/or PUSCHs with different priorities, all of the PUCCHs and/or PUSCHs associated (e.g., overlapping) with the multiplexed PUCCH and/or PUSCH should satisfy the predefined timing condition for multiplexing. The predefined timing relationship may be the timing conditions to be satisfied for multiplexing as defined in 3GPP TS38.213 R15. The predefined timing relationship may be the timing conditions to be satisfied for multiplexing as specified in other embodiments of the disclosure. All of the PUCCHs and/or PUSCHs associated (e.g., overlapping) with the multiplexed PUCCH and/or PUSCH may be determined according to the method of determining a set A in other embodiments of the disclosure. The PUCCH may be a PUCCH with the higher priority and/or the lower priority, and the PUSCH may be a PUSCH with the higher priority and/or the lower priority.

If the UE is configured to support simultaneous transmission of a PUCCH and a PUSCH, all of the PUCCHs and/or PUSCHs associated (e.g., overlapping) with the multiplexed PUCCH and/or PUSCH may not include a PUSCH supporting simultaneous transmission of a PUCCH and the PUSCH.

Herein, the “PUSCH supporting simultaneous transmission of the PUCCH and the PUSCH” may be replaced with the “PUSCH supporting simultaneous transmission of the PUCCH and the PUSCH and not overlapping with another PUSCH in the same serving cell in time domain”. The scheduling of the PUSCH is not affected by other PUCCHs and/or PUSCHs, and does not need to satisfy the timing condition for multiplexing and/or prioritization, so that the scheduling flexibility of the PUSCH can be improved and the delay of the uplink data transmission can be reduced.

FIG. 9B illustrates a PUCCH overlapping with a PUSCH in time domain according to an embodiment.

Referring to FIG. 9B, a PUCCH may overlap with multiple PUSCHs in time domain, and a PUSCH may also overlap with multiple PUCCHs in time domain. How to determine a timing condition that the PUCCH and the PUSCH should satisfy is a problem to be addressed. At least one of the following approaches may be adopted.

Approach MN32 (i.e., a thirty-second approach): it may be specified by protocols and/or configured by higher layer signaling that a set of PUCCHs and/or PUSCHs that overlaps in time domain should satisfy the predefined timing condition. A set of PUCCHs and/or PUSCHs may be determined according to the following steps 1 to 3.

Step 1: a PUCCH and/or PUSCH with the earliest starting symbol and a PUCCH and/or PUSCH overlapping with the PUCCH in time domain are determined. The determined PUCCH and/or PUSCH is put (e.g., included) in a set A.

Step 2: a PUCCH and/or PUSCH overlapping with PUCCHs and/or PUSCHs in the set A in time domain is determined. The determined PUCCH and/or PUSCH is put (e.g., included) in the set A.

Step 3: step 2 is repeated until no more elements are added in the set A.

PUCCHs and/or PUSCHs in the set A are the determined set of PUCCHs and/or PUSCHs.

The PUSCHs in the set A may not include a PUSCH supporting simultaneous transmission of a PUCCH and the PUSCH. Alternatively, the PUSCHs in the set A may not include a PUSCH that supports simultaneous transmission of a PUCCH and the PUSCH and does not overlap with another PUSCH in a same serving cell in time domain.

The starting symbol and the start position may be used interchangeably, and the end symbol and the end position may be used interchangeably. In some implementations, the starting symbol may be replaced with the end symbol, and/or the end symbol may be replaced with the starting symbol.

The PUCCH that should satisfy the predefined timing condition may include respective PUCCHs in the HARQ-ACK multiplexing process.

FIG. 9C illustrates HARQ-ACK multiplexing according to an embodiment.

Referring to FIG. 9C, an SPS HARQ-ACK and a dynamically scheduled HARQ-ACK are multiplexed in dynamically scheduled PUCCH resources, and the PUSCH after HARQ-ACK multiplexing does not overlap with the PUSCH in time domain. If DCI indicating HARQ-ACK is received after T0 in FIG. 9C, the UE may multiplex the SPS HARQ-ACK in the PUSCH. When the UE receives the dynamically indicated HARQ-ACK, the UE may consider it as wrong scheduling, where T0 is the last time of a DCI reception that satisfies the timing condition for multiplexing with the PUSCH.

The method can improve the reliability of the uplink transmission, and reduce the implementation complexity of the UE.

If a PUCCH with HARQ-ACK with the lower priority overlaps with more than one time unit (e.g., PUCCH slot, PUCCH subslot) with the higher priority in time domain, or if the PUCCH with the HARQ-ACK with the lower priority overlaps with more than one PUCCH with the higher priority in time domain, or if the PUCCH with the HARQ-ACK with the lower priority overlaps with more than one PUCCH with HARQ-ACK with the higher priority in time domain, it may be specified by protocols and/or configured by higher layer signaling and/or indicated by dynamic signaling that a transmitted PUCCH is determined by adopting at least one of the following approaches MN33˜-MN37.

Approach MN33 (i.e., a thirty-third approach): if there is at least one PUCCH with dynamically scheduled HARQ-ACK with the higher priority among PUCCHs with the higher priority that overlap with the PUCCH with the HARQ-ACK with the lower priority, the HARQ-ACK with the lower priority is multiplexed with the first (or last) dynamically scheduled HARQ-ACK with the higher priority (e.g., the HARQ-ACK with the lower priority is multiplexed in a PUCCH of the first (or last) dynamically scheduled HARQ-ACK with the higher priority).

Approach MN34 (i.e., a thirty-fourth approach): if there is no PUCCH with dynamic scheduled HARQ-ACK with the higher priority among the PUCCHs with the higher priority that overlap with the PUCCH with the HARQ-ACK with the lower priority, and/or if there is at least one PUCCH with HARQ-ACK only for SPS PDSCH receptions with the higher priority among the PUCCHs with the higher priority that overlap with the PUCCH with the HARQ-ACK with the lower priority, the HARQ-ACK with the lower priority is multiplexed with a PUCCH of the first (or last) HARQ-ACK only for SPS PDSCH receptions with the higher priority (e.g., the HARQ-ACK with the lower priority is multiplexed in the PUCCH of the first (or last) HARQ-ACK only for SPS PDSCH receptions with the higher priority).

Approach MN35 (i.e., a thirty-fifth approach): if there is at least one PUCCH with the HARQ-ACK with the higher priority among the PUCCHs with the higher priority that overlap with the PUCCH with the HARQ-ACK with the lower priority, the HARQ-ACK with the lower priority is multiplexed with the first (or last) HARQ-ACK with the higher priority (e.g., the HARQ-ACK with the lower priority is multiplexed in a PUCCH of the first (or last) HARQ-ACK with the higher priority); otherwise, the UE does not transmit the PUCCH with the HARQ-ACK with the lower priority.

Approach MN36 (i.e., a thirty-sixth approach): if there is at least one PUCCH without repetitions that carries the HARQ-ACK with the higher priority among the PUCCHs with the higher priority that overlap with the PUCCH with the HARQ-ACK with the lower priority, the HARQ-ACK with the lower priority is multiplexed with the first (or last) HARQ-ACK with the higher priority but without repetitions (e.g., the HARQ-ACK with the lower priority is multiplexed in a PUCCH of the first (or last) HARQ-ACK with the higher priority but without repetitions); otherwise, the UE does not transmit the PUCCH with the HARQ-ACK with the lower priority.

Approach MN37 (i.e., a thirty-seventh approach): if there is at least one PUCCH satisfying a predefined condition COND4 among the PUCCHs with the higher priority that overlap with the PUCCH with the HARQ-ACK with the lower priority, the HARQ-ACK with the lower priority is multiplexed with the first (or last) PUCCH satisfying the predefined condition COND4 (e.g., the HARQ-ACK with the lower priority is multiplexed in the first (or last) PUCCH satisfying the predefined condition COND4); otherwise, the UE does not transmit the PUCCH with the HARQ-ACK with the lower priority.

The predefined condition COND4 may be at least one of:

a PUCCH with the higher priority that may carry the HARQ-ACK with the lower priority;

a PUCCH with the higher priority that may be multiplexed with the HARQ-ACK with the lower priority;

a PUCCH with the HARQ-ACK with the higher priority that is not configured with repetitions;

a PUCCH that is not configured with repetitions;

a PUCCH with the higher priority that is configured by a first specific higher layer signaling (the first specific higher layer signaling may be the 3GPP parameter PUCCH-ResourceSet);

a PUCCH with the higher priority that is configured by a second specific higher layer signaling (the second specific higher layer signaling may be the 3GPP parameter SPS-PUCCH-AN-List); or

a PUCCH with the higher priority that is configured by a third specific higher layer signaling (the third specific higher layer signaling may be the 3GPP parameter n1PUCCH-AN).

For example, the HARQ-ACK with the lower priority is multiplexed in the first (or last) PUCCH without repetitions that is configured by the 3GPP parameter PUCCH-ResourceSet. As another example, the HARQ-ACK with the lower priority is multiplexed in the first (or last) PUCCH without repetitions that is configured by the 3GPP parameter PUCCH-ResourceSet and/or the 3GPP parameter SPS-PUCCH-AN-List.

For example, if at least one of the PUCCHs with the higher priority overlapping with the PUCCH with the HARQ-ACK with the lower priority is a PUCCH without repetitions that is configured by the 3GPP parameter PUCCH-ResourceSet, the HARQ-ACK with the lower priority is multiplexed in the first (or last) PUCCH without repetitions that is configured by the 3GPP parameter PUCCH-ResourceSet. However, if at least one of the PUCCHs with the higher priority overlapping with the PUCCH with the HARQ-ACK with the lower priority is a PUCCH without repetitions that is configured by the 3GPP parameters SPS-PUCCH-AN-List and/or n1PUCCH-AN, the HARQ-ACK with the lower priority is multiplexed in the first (or last) PUCCH without repetitions that is configured by the 3GPP parameters SPS-PUCCH-AN-List and/or n1PUCCH-AN. Otherwise, the UE does not transmit the PUCCH with the HARQ-ACK with the lower priority.

As another example, if at least one of the PUCCHs with the higher priority overlapping with the PUCCH with the HARQ-ACK with the lower priority is a PUCCH without repetitions that is configured by the 3GPP parameters PUCCH-ResourceSet and/or SPS-PUCCH-AN-List, the HARQ-ACK with the lower priority is multiplexed in the first (or last) PUCCH without repetitions that is configured by the 3GPP parameters PUCCH-ResourceSet and/or SPS-PUCCH-AN-List. Otherwise, the UE does not transmit the PUCCH with the HARQ-ACK with the lower priority.

The method can improve the transmission probability of the HARQ-ACK with the lower priority.

Herein, the “PUCCH configured by the 3GPP parameter PUCCH-ResourceSet” may be used interchangeably with the “PUCCH with the HARQ-ACK scheduled by the DCI”. The “PUCCH configured by the 3GPP parameters SPS-PUCCH-AN-List and/or n1PUCCH-AN” may be used interchangeably with the “PUCCH with the HARQ-ACK only for SPS PDSCH reception”.

The method with respect to “multiplexing” in the above-described embodiments of the disclosure may also be applicable to “prioritization”. For example, “multiplexing with A” may be replaced with “multiplexing and/or prioritization with A”. As another example, “multiplexing in resource B” may be replaced with “multiplexing and/or prioritization with resource B”.

The PUCCH with the HARQ-ACK with the lower priority may be a PUCCH with HARQ-ACK and/or SR and/or CSI with the lower priority, and the PUCCH with the HARQ-ACK with the higher priority may be a PUCCH with HARQ-ACK and/or SR with the higher priority.

Herein, the “PUCCH with the HARQ-ACK with the higher priority” may be replaced with the “PUCCH with the HARQ-ACK with the higher priority that is a PUCCH resource configured by higher layer signaling for transmitting HARQ-ACK”, or the “PUCCH configured by the 3GPP parameter PUCCH-ResourceSet”, or the “PUCCH configured by the 3GPP parameters PUCCH-ResourceSet and/or SPS-PUCCH-AN-List and/or n1PUCCH-AN”, or the “PUCCH configured by the 3GPP parameters PUCCH-ResourceSet and/or SPS-PUCCH-AN-List”. In this way, a scenario that the HARQ-ACK with the higher priority and the SR with the higher priority are multiplexed in a PUCCH resource of SR may be excluded, and at this time, the PUCCH of SR can only carry 2-bits HARQ-ACK information at most.

If a PUCCH with HARQ-ACK with the higher priority is a PUCCH resource of SR with the higher priority, and the PUCCH with the HARQ-ACK with the higher priority overlaps with a PUCCH with HARQ-ACK with the lower priority in time domain, at least one of the following approaches may be adopted to determine a PUCCH for UE transmission. For example, a first PUCCH format 1 with the SR with the higher priority, a second PUCCH format 1 with the HARQ-ACK with the higher priority and a third PUCCH with the HARQ-ACK with the lower priority overlap in time domain. The UE first resolves a conflict between the second PUCCH format 1 with the HARQ-ACK with the higher priority and the first PUCCH format 1 with the SR with the higher priority, and would transmit the HARQ-ACK with the higher priority with the first PUCCH format 1. (The UE does not transmit the second PUCCH format 1). Thereafter, at least one of the following approaches MN38-MN40 may be adopted to determine the PUCCH for UE transmission.

Approach MN38 (i.e., a thirty-eighth approach): the UE transmits the PUCCH with the HARQ-ACK with the higher priority, and/or the UE does not transmit the PUCCH with the HARQ-ACK with the lower priority. The method can improve the reliability of transmission of the HARQ-ACK with the higher priority and the SR with the higher priority.

Approach MN39 (i.e., a thirty-ninth approach): if a sum of a number of the HARQ-ACK bits with the lower priority and a number of the HARQ-ACK bits with the higher priority is equal to 2, the UE multiplexes the HARQ-ACK with the lower priority and the HARQ-ACK with the higher priority in the PUCCH with the higher priority, and/or the UE does not transmit the PUCCH with the lower priority. Otherwise (i.e., if the sum of the number of the HARQ-ACK bits with the lower priority and the number of the HARQ-ACK bits with the higher priority is not equal to 2 or is greater than 2), the UE transmits the PUCCH with the HARQ-ACK with the higher priority, and/or the UE does not transmit the PUCCH with the HARQ-ACK with the lower priority. The method can improve the transmission probability of the HARQ-ACK with the lower priority. Herein, “if a sum of a number of the HARQ-ACK bits with the lower priority and a number of the HARQ-ACK bits with the higher priority is equal to 2” may be replaced with “if a number of the HARQ-ACK bits with the lower priority is 1 and a number of the HARQ-ACK bits with the higher priority is 1”.

Approach MN40 (i.e., a fortieth approach): the UE multiplexes the HARQ-ACK with the lower priority and the HARQ-ACK with the higher priority in the PUCCH with the higher priority, and/or the UE does not transmit the PUCCH with the lower priority. For example, if a sum of a number of the HARQ-ACK bits with the lower priority and a number of the HARQ-ACK bits with the higher priority is equal to 2, the PUCCH with the higher priority is a PUCCH with SR resources. Otherwise, the PUCCH with the higher priority is a PUCCH configured by higher layer signaling for transmitting HARQ-ACK with the higher priority (e.g., the PUCCH configured by the 3GPP parameter PUCCH-ResourceSet and/or the PUCCH configured by SPS-PUCCH-AN-List).

The scheme may also be applicable in the PUCCH configured by the 3GPP parameter n1PUCCH-AN. For example, the “PUCCH with SR with the higher priority” may be replaced with the “PUCCH configured by the 3GPP parameter n1PUCCH-AN”.

Approaches MN38˜MN40 may also be applicable to a scenario in which a PUCCH format 0 with HARQ-ACK and SR with the higher priority overlaps with a PUCCH with HARQ-ACK with the lower priority.

The method can clarify the behavior of the UE, improve the reliability of transmission of the PUCCH with the higher priority, and reduce the transmission delay of the HARQ-ACK.

If a PUCCH with HARQ-ACK and/or an SR with the higher priority is a PUCCH format 0 or format 1, and the PUCCH with the HARQ-ACK with the higher priority overlaps with a PUCCH with HARQ-ACK with the lower priority in time domain, at least one of approaches MN38, MN39 and MN42 may be adopted to determine the PUCCH for UE transmission.

Approach MN42 (i.e., a forty-second approach): if a sum of a number of the HARQ-ACK bits with the lower priority and a number of the HARQ-ACK bits with the higher priority is equal to 2, the UE multiplexes the HARQ-ACK with the lower priority and the HARQ-ACK with the higher priority in the PUCCH with the higher priority. Otherwise, the UE multiplexes the HARQ-ACK with the lower priority and the HARQ-ACK with the higher priority in another PUCCH with the higher priority. The other PUCCH may be a PUCCH configured by higher layer signaling for transmitting HARQ-ACK with the higher priority (e.g., the PUCCH configured by the 3GPP parameter PUCCH-ResourceSet and/or the PUCCH configured by SPS-PUCCH-AN-List). A number of UCI bits carried by the other PUCCH may be a sum of a number of the HARQ-ACK bits with the lower priority and a number of the HARQ-ACK bits with the higher priority. Alternatively, the number of the UCI bits carried by the other PUCCH may be the sum of the number of the HARQ-ACK bits with the lower priority and the number of the HARQ-ACK bits with the higher priority plus a predefined number of bits (e.g., the predefined number of bits may be 1). The predefined bits may be located after (or before) the HARQ-ACK bits with the higher priority and jointly coded with the HARQ-ACK with the higher priority. The predefined bits may be used to indicate information of the SR with the higher priority. The HARQ-ACK bits with the lower priority are located after (or before) the HARQ-ACK bits with the higher priority and the predefined bits.

The method can improve the transmission probability of the HARQ-ACK with the lower priority. Since the BS is not sure whether the UE has SR to report, reserving of bits for SR can improve the reliability of transmission of the SR. The number of bits of the UCI in the method is the same for positive SR and negative SR, which can reduce the blind detection of the BS and improve the reliability of the HARQ-ACK information.

Herein, “if a sum of a number of the HARQ-ACK bits with the lower priority and a number of the HARQ-ACK bits with the higher priority is equal to 2” may be replaced with “if a number of the HARQ-ACK bits with the lower priority is 1 and a number of the HARQ-ACK bits with the higher priority is 1”.

FIG. 10 is a flowchart illustrating a method performed by a terminal according to an embodiment.

Referring to FIG. 10, in step S1010, a downlink signal is received, where the downlink signal includes a PDSCH and/or a PDCCH.

In step S1020, an uplink signal to be transmitted is determined based on the downlink signal, where the uplink signal includes at least one of a PUCCH or a PUSCH.

For example, the above operations or other operations in the method 1000 may be implemented with reference to one or more of the above-described embodiments. For example, the method 1000 may include one or more of the operations performed by the terminal (e.g., a UE) that are described in various embodiments of the disclosure.

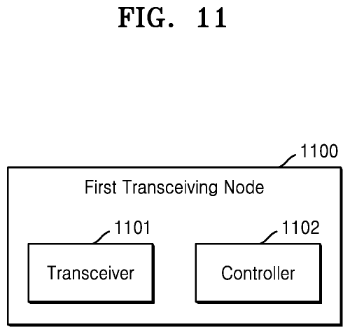

FIG. 11 illustrates a first transceiving node according to an embodiment.

Referring to FIG. 11, the first transceiving node 1100 (e.g., a BS) includes a transceiver 1101 and a controller 1102.

The transceiver 1101 may be configured to transmit first data and/or first control signaling to a second transceiving node and receive second data and/or second control signaling from the second transceiving node in a time unit.

The controller 1102 may be an ASIC or at least one processor. The controller 1102 may be configured to control the overall operation of the first transceiving node 1100, including controlling the transceiver 1101 to transmit the first data and/or the first control signaling to the second transceiving node and receive the second data and/or the second control signaling from the second transceiving node in a time unit.

The controller 1102 may be configured to perform one or more of operations in the methods of various embodiments described above.

Herein, a BS is taken as an example (but not limited thereto) to illustrate the first transceiving node 1100, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

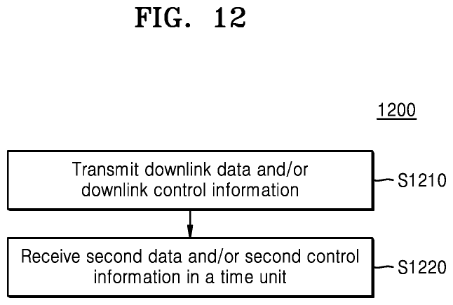

FIG. 12 is a flowchart illustrating a method performed by a BS according to an embodiment.

Referring to FIG. 12, in step S1210, the BS transmits downlink data and/or downlink control information.

In step S1220, the BS receives second data and/or second control information from a UE in a time unit.

For example, the method 1200 may include one or more of the operations performed by the BS in the above-described embodiments of the disclosure.

The downlink channel may include a PDCCH and/or a PDSCH. The uplink channel may include a PUCCH and/or a PUSCH.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an ASIC, a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, erasable programmable read-only memory (EPROM) memory, electrically erasable programmable read-only memory (EEPROM) memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. A method performed by a terminal in a wireless communication system, the method comprising:
receiving a radio resource control (RRC) message including information related to a semi persistent scheduling (SPS) hybrid automatic repeat request (HARQ) deferral;
performing at least one of multiplexing or prioritization among a first physical uplink control channel (PUCCH) and one or more uplink channels when the first PUCCH overlaps with the one or more uplink channels;
identifying a PUCCH resource for a PUCCH transmission with HARQ-acknowledgement (ACK) information for SPS physical data shared channel (PDSCH) receptions based on a result of performing at least one of the multiplexing or the prioritization in a first slot;
determining a second slot based on the RRC message, when the PUCCH resource overlaps with at least one of a downlink symbol, a synchronization signal and physical broadcast channel (SS/PBCH) block or a control resource set0 (CORESET0); and
transmitting the HARQ-ACK information for the SPS PDSCH receptions in the second slot.

2. The method of claim 1, wherein information about the PUCCH resource is provided by a list of resources.

3. The method of claim 1, further comprising, when a priority of the one or more uplink channels is larger than a priority of the first PUCCH, performing cancellation of the first PUCCH.

4. The method of claim 1, wherein the downlink symbol is indicated by an RRC message including information about a time division duplex uplink/downlink (TDD UL/DL) configuration.

5. The method of claim 1, further comprising receiving an RRC message including information about PUCCH repetition,
wherein a priority of the RRC message including information about PUCCH repetition is different than a priority of the RRC message including information related to the SPS HARQ deferral.

6. A method performed by a base station (BS) in a wireless communication system, the method comprising:
transmitting a radio resource control (RRC) message including information related to a semi persistent scheduling (SPS) hybrid automatic repeat request (HARQ) deferral; and
when a physical uplink control channel (PUCCH) resource for a PUCCH transmission with HARQ-Acknowledgement (ACK) information for SPS physical data shared channel (PDSCH) receptions overlaps with at least one of a downlink symbol, a synchronization signal and physical broadcast channel (SS/PBCH) block or a control resource set 0 (CORESET0), receiving the HARQ-ACK information for the SPS PDSCH receptions in a second slot determined based on the RRC message,
wherein the PUCCH resource is identified based on the result of at least one of multiplexing or prioritization in a first slot among a first PUCCH and one or more uplink channels when the first PUCCH overlaps with the one or more uplink channels.

7. The method of claim 6, wherein information about the PUCCH resource is provided by a list of resources.

8. The method of claim 6, when a priority of the one or more uplink channels is larger than a priority of the first PUCCH, performing cancellation of the first PUCCH.

9. The method of claim 6, wherein the downlink symbol is indicated by an RRC message including information about time division duplex uplink/downlink (TDD UL/DL) configuration.

10. The method of claim 6, further comprising transmitting an RRC message including information about PUCCH repetition,
wherein a priority of the RRC message including information about PUCCH repetition is different than a priority of the RRC message including information related to the SPS HARQ deferral.

11. A terminal for use in a wireless communication system, the terminal comprising:
a transceiver, and
at least one controller configured to:
receive a radio resource control (RRC) message including information related to a semi persistent scheduling (SPS) hybrid automatic repeat request (HARQ) deferral,
perform at least one of multiplexing or prioritization among a first physical uplink control channel (PUCCH) and one or more uplink channels when the first PUCCH overlaps with the one or more uplink channels,
identify a PUCCH resource for a PUCCH transmission with HARQ-acknowledgement (ACK) information for SPS physical data shared channel (PDSCH) receptions based on a result of performing at least one of the multiplexing or the prioritization in a first slot,
determine a second slot based on the RRC message, when the PUCCH resource overlaps with at least one of a downlink symbol, a synchronization signal and physical broadcast channel (SS/PBCH) block or a control resource set0 (CORESET0), and
transmit the HARQ-ACK information for the SPS PDSCH receptions in the second slot.

12. The terminal of claim 11, wherein information about the PUCCH resource is provided by a list of resources.

13. The terminal of claim 11, wherein the at least one controller is further configured to, when a priority of the one or more uplink channels is larger than a priority of the first PUCCH, perform cancellation of the first PUCCH.

14. The terminal of claim 11, wherein the downlink symbol is indicated by an RRC message including information about a time division duplex uplink/downlink (TDD UL/DL) configuration.

15. The terminal of claim 11, wherein the at least one controller is further configured to receive an RRC message including information about PUCCH repetition,
wherein a priority of the RRC message including information about PUCCH repetition is different than a priority of the RRC message including information related to the SPS HARQ deferral.
